(19) United States
(12) Patent Application Publication
(10) Pub. No.: US 2026/0204154 A1
(43) Pub. Date: Jul. 16, 2026

(54) Portable Artificial Intellegence Safety Apparatus with Digital Twin Integration, Adaptive Micro-Mobility Collision Avoidance, and Decentralized Edge Training

(71) Applicant: Srijon Mandal, Pleasanton, CA (US)

(72) Inventor: Srijon Mandal, Pleasanton, CA (US)

(21) Appl. No.: 19/449,374

(22) Filed: Jan. 14, 2026

Related U.S. Application Data
(60) Provisional application No. 63/745,577, filed on Jan. 15, 2025.

(51) Int. Cl. G08G 1/01; G08G 1/015; G08G 1/04; G08G 1/065

(52) U.S. Cl. CPC G08G 1/0137; G08G 1/015; G08G 1/04; G08G 1/065

(57) ABSTRACT

A portable artificial intelligence safety apparatus and associated hazard detection device are disclosed. The apparatus includes a single-board computer with a hardware AI accelerator and a multi-modal sensor suite comprising an optical camera, solid-state LiDAR, and thermal infrared camera. A modular mounting architecture enables attachment to diverse vehicle types. Fused sensor data is processed by an ensemble of object detection models and a situational rules engine to compute time-to-collision, detect traffic congestion, and classify objects, including trucks, trees, animals, humans, and stationary structures. The system issues multi-modal alerts and monitors driver rule adherence and drowsiness to form driver-specific behavioral profiles, which may be correlated with geolocation data for traffic planning. In some embodiments, a V2X module and infrastructure data receiver refine safety metrics. A companion device supports localized model evolution via a paired mobile device, enabling deployment of updated models without cloud connectivity.

### FIELD OF THE DISCLOSURE

This application claims priority to U.S. Provisional Patent No. 63/745,577 entitled “Portable AI-Powered Device for Traffic Sign Detection, Voice-assisted Alerts, Driver Behavior Monitoring, Road-Safety Reporting and Urban Traffic Management Using Real-Time Processing and Cloud Integration” filed on Jan. 15, 2025.

The present disclosure generally relates to the field of intelligent transportation systems (ITS), advanced driver-assistance systems (ADAS), and micro-mobility safety technologies. More particularly, the disclosure relates to a portable, sensor-fusion-based apparatus capable of real-time traffic sign detection, collision warning, and behavioral monitoring for diverse vehicle types including automobiles, electric bicycles (eBikes), electric scooters (eScooters), and electric wheelchairs.

### BACKGROUND

The modern transportation landscape is characterized by a persistent and tragic crisis in road safety. Each year, road accidents result in significant human and economic losses globally, with over 38,000 fatalities annually in the United States alone.1 While the automotive industry has made substantial strides in integrating Advanced Driver-Assistance Systems (ADAS) into modern luxury and mid-range vehicles—featuring capabilities such as lane-keeping assistance, automatic emergency braking, and traffic sign recognition—a vast technological disparity remains. A significant portion of the global population, particularly in the United States, continues to operate older automobiles that completely lack these safety features. Budget-conscious users are often priced out of the safety market, leaving them vulnerable to preventable accidents caused by human error, distracted driving, and poor visibility.

### The Micro-Mobility Surge and Vulnerable Road Users

The limitations of current safety technologies are even more pronounced in the rapidly expanding sector of micro-mobility. The proliferation of electric bicycles (eBikes) and electric scooters (eScooters) has introduced a new class of vulnerable road users who operate at speeds significantly higher than pedestrians—often exceeding 20 mph—yet lack the structural protection of automobiles. Research indicates that e-scooter riders face unique risks; safety concerns drive them onto sidewalks, endangering pedestrians, while riding on roads exposes them to high-speed vehicular traffic.2 Furthermore, e-scooters and e-bikes lack the sophisticated sensor suites found in cars to detect impending collisions, blind-spot hazards, or rapidly approaching vehicles from the rear. Regulatory solutions are inconsistent, and there is a lack of agreed-upon metrics for pedestrian safety in shared spaces, such as Time-to-Collision (TTC) thresholds specifically adapted for the agility and fragility of micro-mobility vehicles. Technological Gaps in Accessibility for the Mobility Impaired

Perhaps the most underserved demographic in the current landscape of intelligent transportation is the mobility-impaired community. There is a profound lack of specialized, intelligent safety devices for electric wheelchairs. Users of powered mobility aids frequently navigate complex urban environments where they share space with fast-moving vehicles, pedestrians, and cyclists. The geometric and kinematic constraints of wheelchairs differ vastly from cars and bicycles; they operate at lower speeds but require high-precision obstacle detection for navigation through tight spaces, doorways, and crowds. Existing aftermarket dashcams or cycling radars are ill-suited for this purpose, as they lack the ability to detect negative obstacles (drop-offs/curbs) or provide feedback mechanisms suitable for users with limited motor control or visual impairments.

### Limitations of Static Detection Models

Current traffic sign recognition systems rely heavily on static, pre-trained datasets. In the United States, there is no unified, continuously updated, pretrained dataset for comprehensive detection of traffic signs that accounts for the immense regional variance in signage conditions, lighting, and temporary construction warnings. Existing systems operate largely as “black boxes,” lacking the ability for the end-user or a local administrator to label unique, localized hazards and retrain the model directly on the edge device. This reliance on centralized, static models means that a device deployed in a rural environment with faded signage may perform poorly compared to one in a well-maintained urban center, with no mechanism for the user to rectify this performance gap locally.

### The Disconnect Between Hardware and User Experience

Finally, there is a functional disconnect between portable safety hardware and the powerful mobile devices users already carry. Current aftermarket safety devices typically act as standalone units with limited user interactivity, often requiring cumbersome cable connections for updates or configuration. They fail to leverage the immense processing power, connectivity, and sensor suites (IMUs, GPS, high-res cameras) of modern smartphones. There is an unmet need for a system where a mobile app serves not just as a display, but as a “digital twin” a computational extension of the hardware that provides an interface for real-time telemetry, augmented reality (AR) based sensor calibration, and decentralized model evolution.

### SUMMARY

The present disclosure addresses the aforementioned deficiencies in the art by providing a comprehensive, portable AI-powered safety ecosystem. This system uniquely integrates a high-performance single-board computer with a multi-modal sensor suite (Lidar, Thermal, HD, and Depth Cameras) and connects seamlessly to a mobile application (the RODAN App) acting as a digital twin.

A portable artificial intelligence (AI) safety apparatus and associated hazard detection device are disclosed. The apparatus is built around a single-board computer equipped with a dedicated hardware AI accelerator and a multi-modal sensor suite including at least an optical camera, a solid-state LiDAR sensor, and a thermal infrared camera. The apparatus is mountable on a wide range of vehicles via a modular mounting architecture with interchangeable brackets and is configured to compute time-to-collision from fused sensor data and generate multi-modal alerts. The single-board computer executes an ensemble of trained object detection models and a situational rules engine that can recognize traffic congestion, classify objects into fine-grained categories such as trucks, trees, animals, human beings, and stationary structures, and issue early warnings, including specialized sequences when high-risk objects such as trucks are detected within defined ranges. Additional logic monitors driver adherence to traffic rules by computing violation frequency metrics over sliding temporal windows and, in some embodiments, ingests data from internal-facing sensors that track posture and eyelid movement to derive a comprehensive behavioral awareness profile. The behavioral profile may be aggregated with route history and geolocation data to construct driver-specific profiles usable for urban traffic planning and safety analytics. In further embodiments, the apparatus incorporates a vehicle-to-everything (V2X) communication module, such as a DSRC-based V2V interface operating in the 5.9 GHz band, and a wireless receiver capable of ingesting traffic metrics from highway infrastructure so that external conditions are fused with on-board perception to refine time-to-collision estimates. A companion portable hazard detection device housed for temporary vehicle attachment enables localized model evolution by identifying low-confidence detections on-device, offloading associated images to a paired mobile device for retraining using the phone's neural processing unit, and receiving updated models back over a local wireless link. The updated models are deployed on the device without requiring cloud connectivity, allowing continual adaptation of detection performance to specific geographic environments.

### BRIEF DESCRIPTION OF THE DRAWINGS

The techniques introduced herein are illustrated by way of example, and not by way of limitation in the figures of the accompanying drawings in which like reference numerals are used to refer to similar elements.

FIG. 1 is a high-level block diagram illustrating a system including an agentic platform in accordance with some implementations.

FIG. 2 is a block diagram illustrating a hardware server including the agentic platform in accordance with some implementations.

FIG. 3 is a block diagram illustrating a Driving safety device.

FIG. 4 is a diagram illustrating a the use of the AI Safety apparatus.

FIG. 5 is a block diagram illustrating the operational data flow through the system including the agentic platform in accordance with some implementations.

FIG. 6 is a flow diagram showing a method for object detection.

FIG. 7 is a flow diagram showing a method for pedestrian detection and alert of a driver.

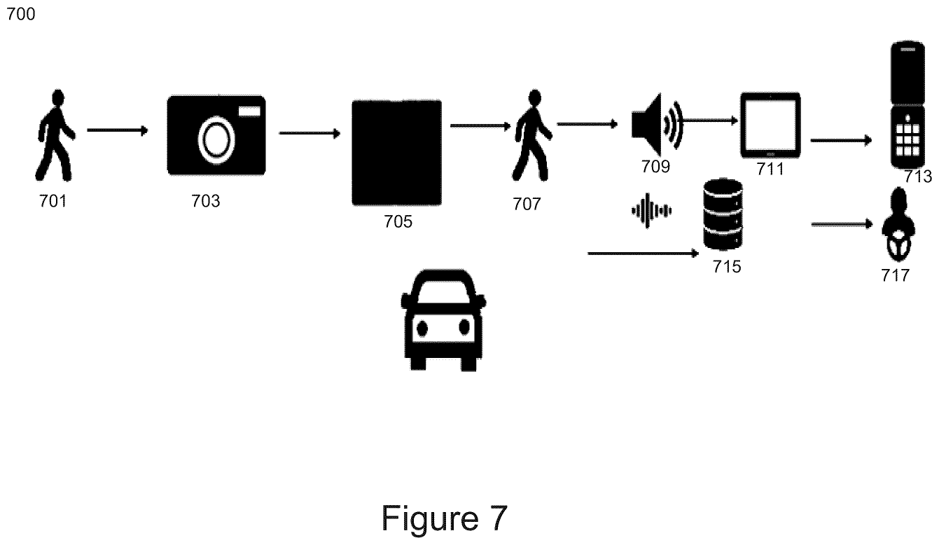

FIG. 8 is a flow diagram showing a method for identification of traffic signs.

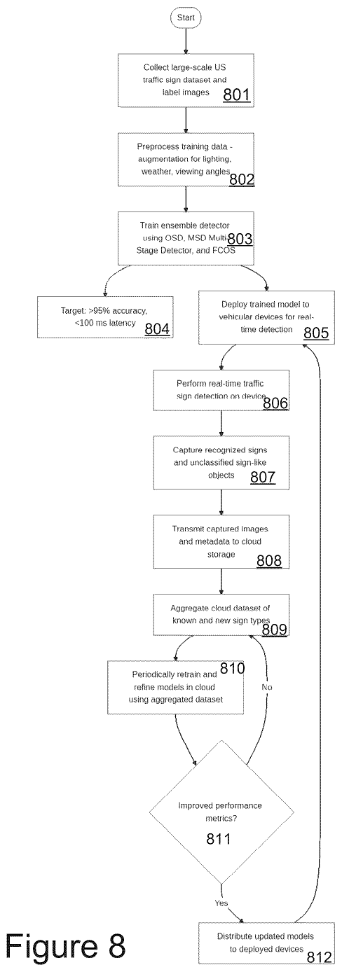

FIG. 9 is a flow diagram showing detection of traffic signs.

FIG. 10 is a representation of a device for holding a portable device and attaching to a micromobility vehicle.

FIG. 11 is a representation of a graphical user interface implemented on a smartphone.

FIG. 12 is a block diagram of an alternative implementation of a portable traffic safety device.

FIG. 13A is a flow chart depicting the real time collision detection logic in one implantation of a portable traffic safety device.

FIG. 13B is a flow chart depicting the decentralized learning workflow of the AI of a portable traffic safety device.

FIG. 14 is a flow diagram depicting implementation of a portable traffic safety device.

FIG. 15 is flow diagram of a portable traffic safety device mounted to the dashboard of a vehicle.

FIG. 16 is flow diagram of a portable traffic safety device mounted to a traffic light or electric light pole.

FIG. 17 is flow diagram of a portable traffic safety device mounted to an electric pole with a voice guardian.

FIG. 18 is a flow diagram of real time collision detection of a portable traffic safety device.

FIG. 19 is a flow diagram of a digital twin ecosystem.

FIG. 20 is a flow diagram integration of a portable traffic safety device in a cloud environment.

FIG. 21 is process flow diagram of the real time detection logic of a portable traffic safety device.

FIG. 22 is a process flow diagram of a device connectivity and interaction in a digital twin environment.

### DETAILED DESCRIPTION

With reference to the figures, reference numbers may be used to refer to components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

### Hardware and Sensor Fusion

In one aspect, the invention provides a hardware unit comprising a single-board computer (e.g., Raspberry Pi 4B or 5) equipped with hardware AI accelerators such as the Google Coral Edge TPU or Intel Movidius VPU. This computing core interfaces with a sensor array specifically selected to cover the spectrum of visibility limitations: a small form-factor solid-state Lidar for precise ranging up to 40 meters, a high-definition optical camera for high-fidelity sign recognition, a thermal infrared (IR) camera for detecting heat signatures in night or fog conditions, and a depth camera for 3D spatial awareness and near-field obstacle avoidance.

### Adaptive Algorithms for Micro-Mobility

The invention introduces novel collision detection algorithms tailored for eBikes and eScooters. Unlike automotive systems that primarily monitor forward vectors, the present system utilizes inertial measurement units (IMUs) and optical flow analysis to determine the “directionality” of threats. It distinguishes between stationary objects and those on a collision course by fusing vehicle yaw rates with visual data. The system implements customizable alert thresholds, such as a “100 ft/3-second” rule, allowing users to tune the sensitivity of the warnings based on their vehicle's braking capabilities and typical operating speeds.

### Universal Mounting Architecture

A further aspect of the invention is its versatile mounting architecture. Customizable brackets and clampening interfaces are disclosed for attachment to diverse form factors: standard vehicle dashboards, tubular handlebars of eBikes/eScooters, electric wheelchair frames, and stationary infrastructure like electric poles or traffic sign poles for municipal traffic monitoring. This modularity ensures that the benefits of AI safety are accessible to all road users, regardless of their mode of transport.

### The RODAN Digital Twin Ecosystem

The invention includes a companion mobile application, the RODAN App, which functions as a digital twin of the physical device. This application leverages the smartphone's ARKit/ARCore capabilities to visualize the hardware's sensor field-of-view (FOV) and guide the user in precise calibration. It provides granular administrative features, allowing users to configure collision zones, view real-time motion/speed telemetry, and manage the device's connectivity.

### Decentralized and Background Training

Crucially, the system features a decentralized learning pipeline. The hardware identifies “unique” or low-confidence traffic sign images during operation and transfers them to the RODAN App. The app then utilizes the smartphone's Neural Processing Unit (NPU) to label and retrain the classification model in the background. Once updated, the improved model is “shipped” back to the hardware unit. This feedback loop allows the system to adapt to local environments without necessitating continuous cloud connectivity or heavy data upload costs.

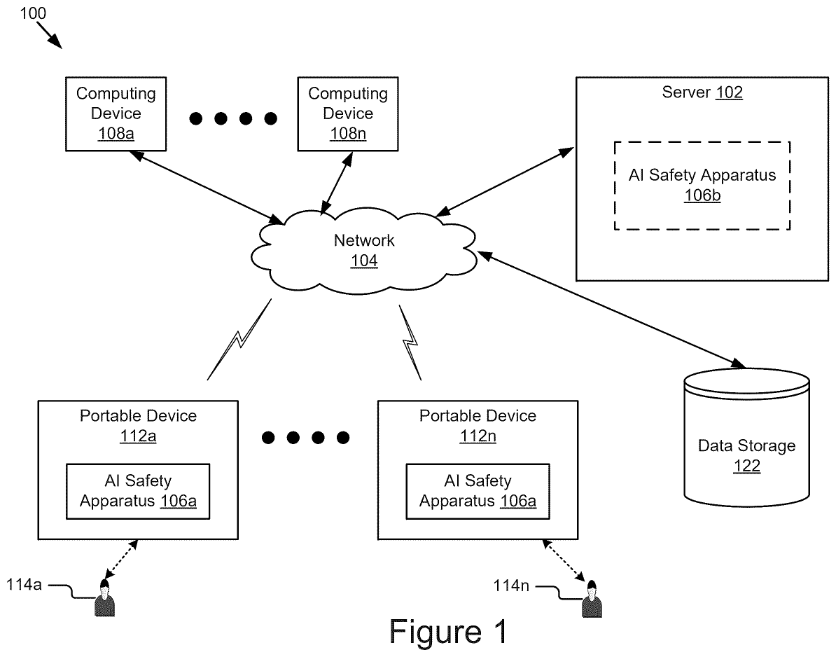

FIG. 1 is a high-level block diagram illustrating the system 100 including the StoreOS agentic platform 120 having biometric authentication according to some implementations. The system 100 includes a server 102, a network 104, one or more computing devices 108a-108n, 112a-112n, and 116a-116n. While a particular arrangement is depicted in FIG. 1 by way of example, it should be noted that other system configurations are possible including other devices, systems, and networks as well as pluralities of any of the components shown in FIG. 1.

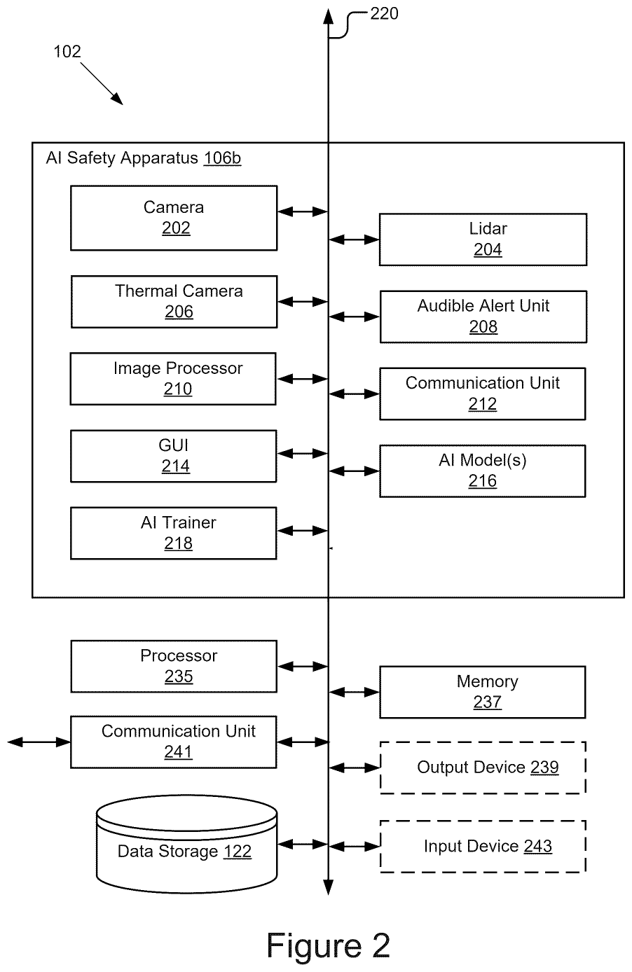

The server 102 is coupled to communicate with other components of the system 100 via the network 104. The server 102 includes the StoreOS agentic platform 120 and data storage 122. The server 102 cooperates via the network 104 with the one or more computing devices 108a-108n, 112a-112n, and 116a-116n to provide the functionality of the present disclosure. The server 102 has data processing and communication capabilities and will be described in more detail below with reference to FIG. 2.

The network 104 may communicatively couple the various components of the system 100. In some implementations, the network 104 is a wired or wireless network, and may have numerous different configurations. Furthermore, the network 104 may include a local area network (LAN), a wide area network (WAN) (e.g., the internet), and/or other interconnected data paths across which multiple devices may communicate. In some implementations, the network 104 may be a peer-to-peer network. The network 104 may also be coupled with portions of a telecommunications network for sending data using a variety of different communication protocols. In some implementations, the network 104 may include Bluetooth (or Bluetooth low energy) communication networks or a cellular communications network for sending and receiving data including via short messaging service (SMS), multimedia messaging service (MMS), hypertext transfer protocol (HTTP), direct data connection, wireless access point (WAP), email, etc. Although the example of FIG. 1 illustrates a network 104, in practice one or more networks can connect the entities of the system 100.

The computing devices 108, 112, 116 may include one or more computing devices having data processing and communication capabilities. FIG. 1 illustrates an implementation of the system 100 having a plurality of computing devices 108a-108n, and a plurality of computing devices 112a-112n, and a plurality of computing devices 116a-116n. The computing devices 108, 112, 116 are coupled by the network 104 to each other and the server 102.

Referring now to FIG. 2, the server 102 including the StoreOS agentic platform 120 is described. In some implementations, the server 102 is a hardware server. In other implementations, the server 102 is a combination of a hardware server and the software server. In still other implementations, the server 102 is entirely a software server. In some implementations, the server 102 includes a processor 235, memory 237, a communication unit 241, the data storage 122, an output device 239, an input device 243, and the StoreOS agentic platform 120. The StoreOS agentic platform 120, the processor 235, memory 237, the communication unit 241, the data storage 122, the output device 239, and the input device 243 are communicatively coupled with each other for communication and cooperation by the bus 220. The server 102 depicted in FIG. 2 is provided by way of example and it should be understood that it may take other forms and include additional or fewer components without departing from the scope of the present disclosure. For instance, various components of the server 102 may be coupled for communication using a variety of communication protocols and/or technologies including, for instance, communication buses, software communication mechanisms, computer networks, etc. While not shown, the server 102 may include various operating systems, sensors, additional processors, and other physical configurations. The processor 235, memory 237, communication unit 241, etc., are representative of one or more of these components.

The bus 220 can include a communication bus for transferring data between components of the server 102, a network bus system including the network 104 or portions thereof, a processor mesh, a combination thereof, etc. In some implementations, the various components of the server 102 cooperate and communicate via a communication mechanism included in or implemented in association with the bus 220. In some implementations, the bus 220 may be a software communication mechanism including and/or facilitating, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, communication between components of server 102 via bus 220 may be secure (e.g., SSH, HTTPS, etc.).

In some implementations the AI Safety Apparatus 106b includes a camera 202, a thermal camera 206 an image processor 210 a GUI 214, an AI trainer 218, a Lidar 204, An audible alert unit 208, a communication unit 212, various AI models 216.

The processor 235 is configured to execute software instructions by performing various input, logical, and/or mathematical operations. The processor 235 may have various computing architectures to process data signals (e.g., CISC, RISC, etc.). The processor 235 may be physical and/or virtual and may include a single core or plurality of processing units and/or cores. In some implementations, the processor 235 may be coupled to the memory 237 via the bus 220 to access data and instructions therefrom and store data therein. The bus 220 may couple the processor 235 to the other components of the server 102 including, for example, the StoreOS agentic platform 120, the communication unit 241, and the output device 239. The processor 235 is also coupled by the communication unit 241 with the network 104 to retrieve and store information from the other components of the system 100.

The memory 237 is configured to store and provide access to data to the other components of the server 102. The memory 237 may be included in a single computing device or a plurality of computing devices. In some implementations, the memory 237 may store instructions and/or data that may be executed by the processor 235. The memory 237 is also capable of storing other instructions and data, including, for example, an operating system, hardware drivers, other software applications, databases, etc. (not shown). The memory 237 may be coupled to the bus 220 for communication with the processor 235 and the other components of server 102. The memory 237 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 235. In some implementations, the memory 237 may include one or more of volatile memory and non-volatile memory (e.g., RAM, ROM, flash memory, hard disk, optical disk, etc.). The memory 237 may be a single device or may include multiple types of devices and configurations.

The communication unit 241 may include one or more interface devices (I/F) for wired and/or wireless connectivity among the components of the server 102 and the network 104. For instance, the communication unit 241 may include, but is not limited to, various types of known connectivity and interface options. The communication unit 241 may be coupled to the other components of the server 102 via the bus 220. The communication unit 241 can provide other connections to the network 104 and to other systems, devices and databases of the system 100 using various standard communication protocols.

The data storage 122 can include one or more non-transitory computer-readable media for storing the data. In some implementations, the data storage 122 may be incorporated with the memory 237 or may be distinct therefrom. In some implementations, the data storage 122 may include a database management system (DBMS). For example, the DBMS could include a structured query language (SQL) DBMS, a NoSQL DBMS, various combinations thereof, etc. In some implementations, the DBMS may store data in multi-dimensional tables comprised of rows and columns, and manipulate, e.g., insert, query, update and/or delete, rows of data using programmatic operations. While the data storage 122 is shown in FIGS. 1 and 2 as being part of the server 102, in some implementations the data storage 122 may be directly coupled to the network 104 and not included in the server 102. The server 102 would access the data storage 122 via the network 104 in such an implementation.

The data storage 122 may include one or more data stores that store information about prescription drugs or over-the-counter medications. For example, the data storage 122 may include proprietary or in-house databases maintained by public safety organizations, commercially available databases, and/or databases operated by a government agency.

The output device 239 may be any device capable of outputting information from the server 102. The output device 239 may include one or more of a display (LCD, OLED, etc.), a printer, a 3D printer, a haptic device, audio reproduction device, touch-screen display, a remote computing device, etc. In some implementations, the output device 239 is a display which may display electronic images and data output by a processor, such as processor 235, of the server 102 for presentation to a user. The output device 239 is shown with dashed lines in FIG. 2 to indicate that it is optional.

The input device 243 may include any device for inputting information into the server 102. In some implementations, the input device 243 may include one or more peripheral devices. For example, the input device 243 may include a keyboard, a pointing device, microphone, an image/video capture device (e.g., camera), a touch-screen display integrated with the output device 239, etc. The input device 243 is shown with dashed lines in FIG. 2 to indicate that it is optional.

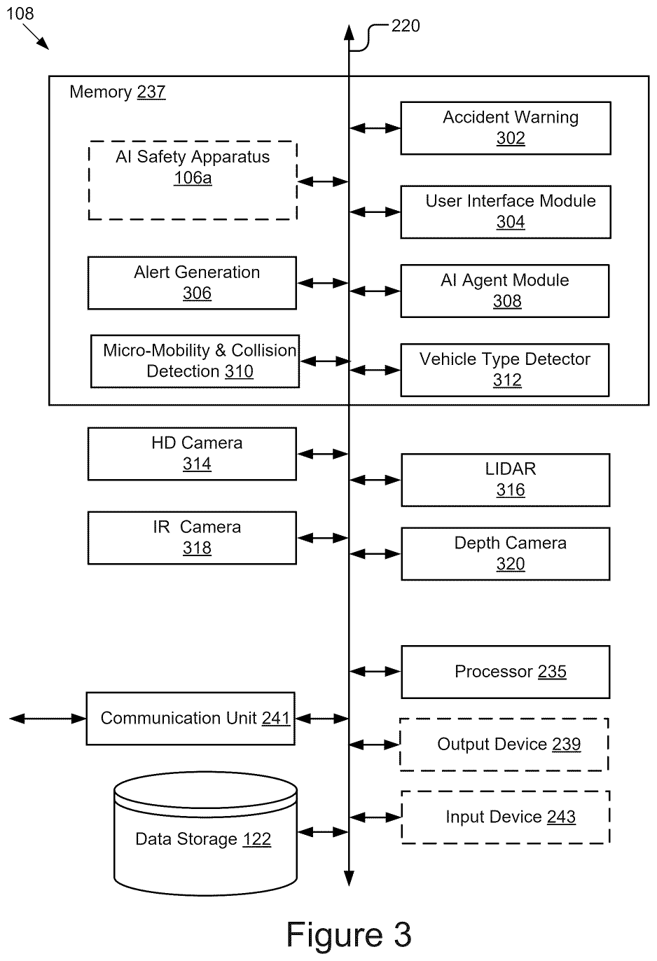

FIG. 3 illustrates an exemplary system architecture of an artificial intelligence-based safety and collision detection apparatus, according to one embodiment. As shown, the system 108 includes a processing environment 220 comprising one or more processors 235 operatively coupled to memory 237. The memory 237 stores instructions and data corresponding to an AI safety apparatus 106a, which may be implemented as one or more software modules, firmware components, or a combination thereof. The AI safety apparatus 106a includes an alert generation module 306 configured to generate safety alerts, and a micro-mobility and collision detection module 310 configured to analyze sensor data to identify potential collision events involving micro-mobility devices and other objects.

The processing environment 220 further includes an accident warning module 302, a user interface module 304, an AI agent module 308, and a vehicle type detector 312, each of which is communicatively coupled to the processor 235 and cooperates with the AI safety apparatus 106a. The vehicle type detector 312 is configured to classify detected objects or vehicles, while the AI agent module 308 performs higher-level reasoning, decision-making, or adaptive behavior based on inferred environmental conditions. The user interface module 304 facilitates interaction with a user, and the accident warning module (302) provides real-time warnings or notifications in response to detected hazards.

A plurality of sensors are operatively coupled to the processing environment 220, including a high-definition camera 314, an infrared camera 318, a LIDAR sensor 316, and a depth camera 320. These sensors supply multi-modal environmental data to the processor 235 for perception, object detection, and spatial analysis. The system further includes a communication unit 241 configured to transmit and receive data over one or more wired or wireless networks, enabling communication with external devices or remote systems. Data generated or utilized by the system may be stored in a data storage device 122, which may include non-volatile or persistent storage.

The processing environment 220 is further operatively coupled to one or more input devices 243 and output devices 239. The input devices 243 may include user controls, touch interfaces, or other data entry mechanisms, while the output devices 239 may include displays, speakers, haptic feedback components, or other alerting interfaces. The bidirectional arrows shown in FIG. 3 represent data and control signal exchanges among the various components, illustrating coordinated operation of the system to perform real-time collision detection, hazard evaluation, and user notification

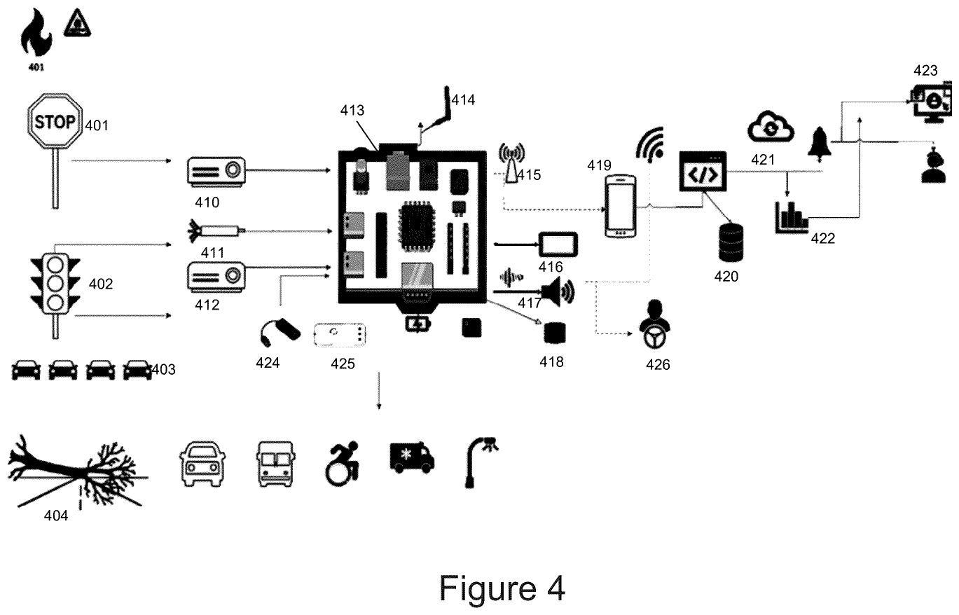

Referring to FIG. 4, in some implementations, a device having a modular system architecture is provided. The device includes hardware configured to perform data acquisition, processing, analysis, and user interaction functions. The hardware can include a single-board computer, one or more imaging subsystems one or more ranging subsystems, a user interface subsystem, and one or more universal input sensing subsystems, as described below.

In certain implementations, the device includes a single-board computer (SBC) 413, such as a Raspberry Pi 4B. The single-board computer is a complete computer implemented on a single circuit board and includes all components necessary for operation of a functional computer system. The single-board computer can include a microprocessor or central processing unit (CPU) configured to execute instructions and control operation of the device. In some implementations, the single-board computer is further configured to support one or more hardware accelerators. For example, the single-board computer can be operatively coupled to a Google Coral Edge TPU accelerator, which is a dedicated accelerator configured to accelerate TensorFlow Lite models and to increase inference speed for object recognition tasks executed by the device. In another example, the single-board computer can be coupled to an Intel Movidius Myriad X vision processing unit (VPU), which is configured to offload computationally intensive vision-related processing tasks from the CPU. The single-board computer additionally includes system memory, such as random-access memory (RAM), that provides volatile storage for active data and executing programs. The single-board computer further includes non-volatile storage, such as flash memory or embedded MultiMediaCard (eMMC) storage, which can store an operating system, application software, configuration data, and logged data; in some implementations, the non-volatile storage is provided via a microSD card interface. The single-board computer further comprises input/output (I/O) ports, which can include connectors for peripheral devices such as keyboards, mice, displays, cameras, and networking interfaces. Power management circuitry is provided on the single-board computer to regulate and distribute electrical power to the various components. Additional supporting circuitry on the single-board computer can include clock generation circuits, communication interfaces (for example, USB, Ethernet, and Wi-Fi interfaces), and other specialized integrated circuits.

In some implementations, the device further includes an infrared (IR) thermal camera 410 configured for environmental monitoring. The IR thermal camera 410 is configured to detect infrared radiation emitted by objects in a field of view and to generate image data based on spatial variations in temperature. The IR thermal camera 410 can be used to acquire imagery in low-light or no-light conditions and can facilitate imaging through certain obscurants such as fog. The thermal image data can be processed to identify heat signatures associated with objects of interest, such as people, animals, or engine components.

The device can also include at least one high-definition camera 412 configured for traffic sign detection or other machine-vision tasks. The high-definition camera 412 can be a color camera operating in the visible light spectrum and configured to capture high-resolution image frames. The image data acquired by the high-definition camera 412 can be used for object recognition, lane detection, traffic sign recognition, and general scene understanding. In some implementations, the device additionally or alternatively supports one or more depth cameras 411, such as an Intel RealSense camera or a Microsoft Kinect camera. The depth camera is configured to provide per-pixel distance or depth information, enabling three-dimensional object detection and distance estimation relative to the device. The depth information can be fused with color imagery or thermal imagery to improve accuracy of object localization and scene interpretation.

In further implementations, the device includes a user interface subsystem comprising an integrated speaker 417 and an electronic display 416. The integrated speaker 417 is configured to generate audible alerts, warnings, and other notifications in response to detected conditions or events. The display 416 can be implemented as a liquid crystal display (LCD) and is configured to present visual information, including alerts, warnings, status indicators, and graphical user interface elements, to a user. In some implementations, the display is a touchscreen display configured to detect user touch input, thereby allowing a user to interact with on-screen elements and to control or acknowledge functions related to the monitored environment or connected systems.

The device also includes at least one ranging subsystem implemented using light detection and ranging (LiDAR) technology. A LiDAR sensor 424 is configured to emit laser pulses into the surrounding environment and to measure a time-of-flight of returned pulses reflected from objects. Based on the measured times, the LiDAR sensor 424 generates distance measurements and a corresponding three-dimensional point cloud representing the environment around the device. The LiDAR subsystem can be used for precise distance measurement, obstacle detection, and map generation. In some implementations, multiple LiDAR units are provided and are connected to the single-board computer, for example, via a powered USB hub that supplies both power and data connectivity. In other implementations, one or more LiDAR sensors are connected via an Ethernet interface to support higher data bandwidth and increased sensor count.

In advanced implementations, the device further includes one or more sensors configured to receive universal input signals. The universal input sensing subsystem 425 can be configured to capture data from vehicular networks and other external systems. For example, the sensors can interface with a vehicle communication bus or other standardized interfaces to acquire operational parameters, diagnostic data, and environmental signals from a vehicle or other external apparatus. The advanced device can thus collect, process, and correlate universal input data from a vehicular network with image, thermal, LiDAR, and other sensor data to provide enhanced situational awareness, decision support, and control capabilities.

The software architecture implements a multi-layered approach incorporating machine learning libraries, custom algorithms, and communication protocols. The system utilizes OpenCV as a foundational image processing library, supplemented by specialized object detection frameworks 418.

### Machine Learning Models and Object Detection

The system employs an ensemble approach utilizing multiple object detection architectures, each selected for specific performance characteristics suited to edge computing constraints. The ensemble includes:

One-Stage Detectors (OSD) including various YOLO (You Only Look Once) architectures, specifically YOLOv8 variants, which directly predict bounding boxes and class probabilities in a single forward pass through the neural network, thereby achieving reduced latency compared to two-stage detection methods.

Single Shot Detectors (SSD) including MobileNet SSD, SSD Lite, and EfficientDet variants, specifically optimized for real-time performance on resource-constrained devices through reduced parameter counts and computational requirements.

Anchor-Free Detectors including CenterNet and FCOS (Fully Convolutional One-Stage Object Detection) architectures, which eliminate the computational overhead associated with anchor box design and processing.

The system implements custom algorithms that combine inferencing capabilities from multiple detector types, enabling simultaneous execution of fire detection models, traffic sign recognition models, and general object analysis models within the computational constraints of the edge device.

### Driver Behavior Monitoring

The system incorporates behavioral analysis software configured to detect distracted and drowsy driving conditions 426. This subsystem utilizes complementary algorithms including Haar Cascade Classifiers for rapid face detection, MediaPipe Face Mesh for detailed facial landmark tracking, Dlib's facial landmark predictor for robust feature extraction, Tiny-YOLO for efficient person detection, MobileNet for classification tasks, and Histogram of Oriented Gradients (HOG) descriptors for feature representation. These algorithms, implemented in Python and C++ libraries, operate in parallel with traffic monitoring functions to provide comprehensive driver safety monitoring.

### Data Management and Cloud Connectivity

The system implements cloud connectivity 421 protocols using Flask-based web services, with data persistence provided by MongoDB or equivalent NoSQL database systems. Cloud services, preferably implemented on Amazon Web Services (AWS) or equivalent platforms, enable data aggregation, model retraining, and dashboard reporting capabilities. Mobile application software facilitates user interaction and real-time alert delivery via Bluetooth communication protocols.

### Edge Computing Optimization

To achieve real-time performance on edge computing hardware, the system implements several optimization strategies:

Model Compression: Smaller neural network architectures with reduced parameter counts are preferentially selected to minimize memory footprint and computational requirements while maintaining acceptable accuracy levels.

Computational Efficiency: Models exhibiting lower FLOPS (Floating Point Operations per Second) requirements are prioritized to ensure inference latency remains within acceptable bounds.

Framework Selection: TensorFlow Lite framework is employed for model deployment, leveraging optimizations specifically designed for edge computing devices.

Quantization: Post-training quantization and quantization-aware training techniques are applied to reduce model size and improve inference speed, achieving substantial performance improvements with minimal accuracy degradation.

Hardware Acceleration: Optional integration with Google Coral Edge TPU accelerators provides dramatic inference speed improvements for TensorFlow Lite models when additional performance is required.

Hardware Selection: The system preferentially utilizes latest-generation Raspberry Pi models offering increased processing power and RAM capacity, enabling deployment of more sophisticated models while maintaining real-time performance.

### Traffic Sign Detection and Recognition

The system implements comprehensive traffic sign detection capabilities specifically tailored to United States traffic signage standards. A proprietary large-scale traffic sign dataset was created, labeled, and used for model training to ensure coverage of diverse sign categories encountered in real-world driving conditions.

A preprocessing pipeline prepares training data through augmentation techniques that simulate varying lighting conditions, weather effects, and viewing angles, thereby improving model robustness under diverse environmental conditions. The ensemble approach combining OSD, MSD (Multi-Stage Detector), and FCOS algorithms achieves a detection accuracy exceeding 95% with inference latency maintained below 100 milliseconds, meeting real-time performance requirements for vehicular applications.

### Continuous Learning and Model Improvement

The system implements a novel continuous improvement mechanism wherein real-time traffic sign detections, including both recognized signs and unclassified sign-like objects, are captured and transmitted to cloud storage systems. This ongoing data collection encompasses new images of both known sign types (to improve recognition under varying conditions) and previously unseen sign types (to expand system capabilities).

The aggregated dataset stored in cloud databases is periodically used to retrain and refine the machine learning models in the cloud computing environment, where computational resources are not constrained. Updated models demonstrating improved performance metrics are subsequently distributed to deployed devices, ensuring continuous enhancement of inferencing quality throughout the system lifecycle.

### Traffic Rule Awareness and Violation Prevention

The system implements a unique traffic rule awareness feature that ranks different traffic regulations by importance and frequency of violation. The system continuously monitors detected signs and current vehicle behavior, generating proactive alerts regarding applicable traffic rules and potential violations before they occur. This predictive warning system enables drivers to maintain compliance and avoid penalties.

Advanced variants of the system incorporate WiFi and other wireless communication capabilities to receive signals from intelligent highway infrastructure systems, enabling integration of additional context such as dynamic speed limits, lane closures, and incident warnings transmitted by roadside equipment.

### Traffic Situation Analysis and Context-Aware Recommendations

The system implements intelligent traffic situation identification by synthesizing information from multiple sources including detected traffic signs, object detection results, and optionally, signals from highway infrastructure systems 422.

### Real-Time Processing Performance

Real-time processing is achieved through optimization of image preprocessing stages and inference pipeline design. The system maintains processing delays not exceeding 0.01 milliseconds from data capture through sensor acquisition to generation of actionable output, as verified through extensive field trials conducted under diverse traffic, weather, and lighting conditions. This latency threshold ensures that system outputs remain temporally relevant for driver decision-making.

### Complex Situation Recognition

The system employs rule-based logic combined with object detection results to identify complex traffic situations that cannot be inferred from individual traffic signs alone. For example, the system detects traffic congestion conditions 403 by continuously monitoring the number of vehicles detected within specified distance ranges (e.g., more than five vehicles within 30 meters) sustained over defined time periods (e.g., 10 minutes). When integrated with highway infrastructure signals, the system enhances situation assessment accuracy by incorporating externally-provided traffic metrics.

This approach represents a novel method of deriving complex traffic situations by combining metrics from multiple simultaneous detection tasks. The system's capability to execute multiple object recognition models concurrently-including fire detection, traffic symbol classification, and comprehensive image analysis-enables sophisticated situational awareness beyond the capabilities of single-purpose systems.

### Adaptive Alert Generation

The advanced alerting mechanism contributes to reduction in speeding tickets and other traffic citations, providing significant practical benefit to system users. The system prevents accidents through intelligent rule tuning based on detected vehicle types in proximity, generating personalized warnings appropriate to specific risk scenarios.

Users are provided configurability options to adjust threshold values for various rule parameters including alert frequency and triggering conditions. For example, the system can be configured to generate early warnings with increased repetition frequency (e.g., five alerts) when large vehicles such as trucks are detected within specified ranges (e.g., 100 meters forward). The system continuously scans distances between the user's vehicle and potential collision objects, classifying detected objects into categories including moving vehicles, stationary objects, physical structures, vegetation, animals, and pedestrians, with alert parameters adjusted according to object classification.

### Context-Aware Speed Recommendations

The system implements a novel context-aware recommendation feature that provides real-time driving guidance based on actual traffic conditions rather than merely repeating posted regulatory information. For example, when a speed limit sign indicating 50 units is detected, but analysis reveals traffic congestion is developing, the system may recommend maintaining the average traffic flow speed (e.g., 45 units) rather than the posted limit, thereby improving traffic flow and reducing accident risk associated with speed differentials.

### Testing and Validation

All features described herein have been subjected to rigorous testing protocols utilizing pretrained machine learning models deployed on target hardware platforms under real-world operating conditions, verifying both functional correctness and performance characteristics meet specified requirements.

### Model Training and Configuration

In accordance with one or more implementations, the system implements a machine learning framework for the detection and classification of traffic-related objects. The training process begins with the preparation and annotation of a specialized dataset. In an exemplary implementation, the dataset comprises approximately 2,000 traffic symbols. Each entry in the dataset is annotated with precise bounding boxes and class labels to facilitate supervised learning.

The object detection architecture is based on a YOLOv9 (You Only Look Once, version 9) model. The model configuration file is modified to define specific iteration counts and custom attributes tailored to the traffic symbol domain. During the training phase, several hyperparameters are tuned to optimize performance based on the dataset size and complexity. These hyperparameters include, but are not limited to:

Batch Size: Adjusted dynamically based on available GPU memory to balance computational throughput and memory constraints.

Initial Learning Rate (lr0): Calibrated to ensure convergence and prevent premature overfitting.

Momentum: Set at an optimized value (e.g., approximately 0.937) to maintain stability during gradient descent.

Weight Decay: Employed within a range of 0.0005 to 0.001 for regularization purposes.

Augmentation Techniques: Implementation of mosaic, mix-up, and color jittering to enhance the robustness of the detector against environmental variations.

The model is trained over a duration of approximately 200 epochs. The training metrics, including loss functions and mean Average Precision (mAP), are monitored to ensure the efficacy of the custom-trained weights. Upon completion, the optimized weights are published to a repository for deployment within the vehicle-mounted device.

### II. Performance Metrics and Evaluation

The effectiveness of the object detection algorithm is measured through rigorous testing across various event scenarios. Table 1 illustrates the comparative accuracy between training and testing phases, as well as the operational latency of the device:

TABLE 1

| Event | Alert | Training | Testing | Inference |
|---|---|---|---|---|
| Description | Message | Accuracy | Accuracy | Latency |
| Pedestrian | “Pedestrian | 90% | 92% | <30 ms |
| detected | is walking” | | | |
| Traffic sign | “Stop sign | 94% | 93% | <25 ms |
| identified | ahead” | | | |
| Violation | “Rule | 89% | 90% | <35 ms |
| detected | violation” | | | |

As demonstrated, the model exhibits high generalization capabilities, often performing better on test datasets than during initial training. Furthermore, the low inference latency ensures real-time feedback when the device is deployed in an active driving environment.

### Driving Behavior Monitoring and Warning System

The system provides continuous monitoring of driver adherence to traffic regulations through an internal scoring algorithm. This algorithm evaluates the frequency of critical rule violations over a rolling window (e.g., the last 60 minutes). By processing both short-term temporal data and long-term historical trends, the system generates driver-specific ratings and warnings. This personalized profile is maintained locally on the device to ensure data security and privacy.

### Drowsiness and Eyelid Detection:

To maintain comprehensive behavioral awareness, the system employs sensor fusion and multi-task learning to monitor driver eyelids using the following methodologies:
Haar Cascade Classifiers: Boosted decision trees for rapid feature detection (edges/corners).
HOG+SVM: Extraction of gradient orientations from the eye region classified via Support Vector Machines.
Object Detection Models: Utilization of Tiny-YOLO or MobileNet SSD to infer eyelid states via bounding box dimensions.
Facial Landmark Predictors: Use of MediaPipe or Dlib to calculate the Eye Aspect Ratio (EAR) for precise closure detection.

### B. Posture and Gaze Estimation:

Simultaneously, the device analyzes physical posture and spatial orientation using:
Perspective-n-Point (PnP) Algorithm: Estimating 3D head orientation (yaw, pitch, and roll) based on facial landmarks.
Human Pose Estimation: Utilizing OpenPose or MediaPipe Pose to analyze shoulder and torso alignment.
Gaze Estimation: Predicting the driver's focal point within the environment to identify distractions.
Upon detection of a rule violation, drowsiness, or improper posture, the system issues multi-modal alerts comprising both audio notifications and visual indicators on the display interface.

### Metrics Dashboards, Reporting, and Long-Term Data Storage

In certain implementations, the system includes functionality for real-time transmission of collected driving, traffic, and environmental data from an in-vehicle or portable device to a cloud-based computing platform. The data transfer may be facilitated through a wireless communication link, such as a Bluetooth® connection between the device and a user's mobile phone, which in turn communicates with a remote server or cloud infrastructure.

The system allows a user to selectively configure which categories of metrics are shared, transmitted, stored, or retained outside the device. Such metrics may include, but are not limited to, traffic conditions, road hazards, environmental events, vehicle operating conditions, and driver behavior parameters. Based on the selected metrics, the cloud-based platform may generate real-time dashboards, historical reports, and analytics summaries accessible through a mobile application or a web-based interface 422.

In some implementations, when the device detects an emergency or abnormal event in proximity to the roadway—such as a fire 401, flood, landslide, accident, or other natural or man-made hazard—the system is configured to generate and transmit an alert in near real time. These alerts may be automatically forwarded to relevant emergency response entities, transportation agencies, or municipal authorities. By way of example and not limitation, notifications may be provided to public transportation agencies or regional transit authorities to enable timely response and coordination.

Additionally, aggregated or event-driven notifications may be transmitted to city or regional transportation offices to support proactive traffic management, congestion mitigation, and deployment of remedial actions. In this manner, the disclosed system enables distributed, real-time highway and roadway monitoring using data collected from multiple participating devices.

In certain implementations, users may retrieve periodic or on-demand reports through a mobile phone application or by logging into a cloud-based application 423. Such reports may include summaries of driving behavior, traffic conditions encountered, historical trends, and comparative analytics over a defined time period.

### Driving and Traffic Pattern Analysis

In further implementations, the device and associated cloud platform are configured to continuously collect, store, and analyze driving behavior data associated with an individual driver. The collected data may include, without limitation, driving paths, speed profiles, acceleration and braking behavior, rule or regulation violations, and geolocation or geo-region information. These data elements may be processed to generate a modeled driver profile representing characteristic driving patterns and tendencies.

The system may employ statistical analysis, machine learning, or predictive modeling techniques to train one or more driver behavior models using the collected data. In certain implementations, such trained models may be published, shared, or deployed to generate predictive insights, personalized driving recommendations, or risk assessments for end users. Driver profiles may be associated with individual drivers, households, vehicle categories (e.g., sedan, sport utility vehicle, sports car), or vehicle manufacturers, thereby providing a comprehensive, multi-dimensional view of driving behavior.

In additional implementations, aggregated and anonymized geolocation-tagged data may be utilized for urban traffic planning and regional traffic analysis. Precise coordinate mapping and spatial tagging enable the generation of comprehensive traffic analytics across different geographic regions. Machine learning models applied to such urban traffic datasets may reveal regional commuting trends, congestion patterns, and behavioral differences across locations.

By way of example, the system may identify that driving behavior in a first geographic region exhibits relatively cautious and slower driving tendencies, whereas a second geographic region demonstrates a higher frequency of rule violations or aggressive driving patterns. Such insights may be leveraged by city planners, transportation agencies, and policy makers to inform infrastructure planning, traffic regulation strategies, and public safety initiatives.

### Rule-Based Compliance and Alert Generation

In accordance with one or more implementations, the system incorporates a rules engine configured to execute specific logical operations based on the confluence of object detection data, vehicle telemetry, and spatial sensor data (e.g., Lidar, GPS). The following exemplary rule sets define the conditional logic and resulting actions performed by the device.

### Traffic Sign Enforcement and Compliance

Speed Limit Enforcement: The system is configured to monitor speed limit compliance by identifying “Speed Limit” traffic signs. A condition is met if a sign is detected and the vehicle's current velocity, retrieved via GPS or vehicle bus interface, exceeds the value indicated on said sign. Upon meeting this condition, the system triggers a multi-modal alert including a visual flashing of the speed limit and an audio prompt (e.g., “Reduce speed”). The event is logged with the speed limit, current speed, GPS coordinates, and a timestamp.

Stop Sign and Signal Compliance: The system detects “STOP” signs 401 and monitors vehicle state to ensure a complete stop for a threshold duration (e.g., at least 2 seconds) prior to a designated stop line. Similarly, for Red Light Violation detection, the system correlates the detection of a “Traffic Light” in a red state with vehicle forward motion past a stop line or into an intersection. Red light violations trigger high-priority alerts, such as a flashing red screen and urgent audio beeps, with the option to log a short video clip of the event.

Sign Classification and Informational Feedback: The system differentiates between General Warning Signs (e.g., “Curve Ahead,” “Slippery Road”), Informational Signs (e.g., “Hospital”), and Prohibitory Signs (e.g., “No Left Turn”). For prohibitory signs, the alert is specifically triggered if the device detects the driver is initiating the prohibited maneuver. While warning and prohibitory signs trigger audio-visual alerts, informational signs may be configured to display text or symbols without an intrusive audio chime, unless otherwise specified by user configuration.

### Pedestrian Safety and Collision Avoidance

Imminent Collision Detection: Utilizing a combination of computer vision and Lidar data, the system identifies pedestrians within a calculated critical distance based on current vehicle speed. If an imminent collision path is detected, the system generates an immediate visual “BRAKE!” message and a high-decibel audio alert. The log entry for such events includes the pedestrian's relative location, distance, and closing speed.

Pedestrian Proximity Awareness: For pedestrians detected near the roadway (e.g., on an adjacent sidewalk) but not currently in the vehicle's path, the system provides a secondary level of awareness. This includes highlighting the pedestrian on the display and issuing a low-urgency caution chime to maintain driver situational awareness.

### Driver State and Environmental Monitoring

Drowsiness and Distraction Logic: The system processes data from the eyelid detection and head pose estimation modules (as described in Section III).

Drowsiness: If the Eye Aspect Ratio (EAR) indicates frequent or prolonged eye closure, or if head pose analysis suggests “nodding,” the system triggers an escalating audio alert and a visual suggestion to “Take a break.” Distraction: If gaze tracking indicates the driver's focus has been diverted from the forward roadway for a period exceeding a calibrated threshold, a steering wheel icon with an exclamation mark is displayed alongside a corrective audio prompt. Object Density and Traffic Flow: The system further evaluates the environment based on vehicle density. By counting the number of vehicles within a specific range, the system can infer “Heavy Traffic” conditions. In such instances, a soft audio prompt and visual notification are issued to prepare the driver for potential congestion or deceleration. Forward Collision Warning (FCW): The Lidar module continuously monitors obstacles (e.g., other vehicles or stationary objects). If the distance to an object decreases at a rate exceeding a safety threshold, a “Warning!Obstacle Ahead!” alert is issued. Data logging for FCW events includes closing speed and object type classification.

### Data Flow Characteristics

The sequence depicted in FIG. 4 demonstrates the multi-modal alert architecture of the present invention, wherein a single detected event triggers coordinated responses across multiple output channels (audio, visual, local storage, mobile device, and cloud services) with appropriate prioritization and timing to ensure driver awareness while maintaining comprehensive data logging for analytical purposes. The parallel execution of Device Actions 4 through 7 ensures minimal latency between event detection and driver notification, with the most time-critical audio and visual alerts generated without waiting for completion of data logging or wireless transmission operations.

The architecture further demonstrates the distributed processing approach, wherein real-time detection and immediate alerting occur on the edge device with computational constraints, while resource-intensive historical analysis and model retraining operations are offloaded to mobile devices and cloud computing infrastructure where computational resources are abundant.

This exemplary implementation illustrates the system's operation for pedestrian detection; however, the identical data flow architecture applies to detection of any object type, traffic sign recognition events, traffic situation identification, or driver behavior monitoring alerts, with variations only in the specific content of generated messages and criticality assessment parameters applied in Device Action-3.

In some implementations, a system and method are provided for city traffic planning using data obtained from a plurality of devices deployed in vehicles or at fixed infrastructure points. In one implementation, each device continuously or periodically collects operational, environmental, and event data during use. Historical data generated by multiple such devices is stored in a cloud-based data store. By aggregating this historical data across a large fleet of devices, the system enables powerful prescriptive analytics. In certain implementations, the collected metrics and event data from the devices are augmented with external datasets, including city infrastructure data, traffic flow information, public and commercial transport schedules, weather information, and other relevant data points. The combined dataset supports comprehensive, city-scale analysis of traffic patterns, congestion behavior, and risk profiles. In some implementations, this integration of multi-source data, as performed using the device and associated cloud services, is a unique capability that enables improved planning and optimization relative to conventional systems.

In various implementations, the system further implements predictive modeling to anticipate traffic congestion and accident risks. Machine-learning or statistical models can be trained on the historical and augmented datasets to forecast congestion at specific locations, times of day, or under given conditions, and to estimate the likelihood of collisions or other traffic incidents. The output of such predictive models can be used by municipalities, transportation authorities, or fleet operators to implement traffic-control strategies, adjust signal timings, optimize routing, or deploy safety resources. In some implementations, the system generates visual insights including geolocation heatmaps and time-series analyses of traffic characteristics. Geolocation heatmaps may depict spatial distributions of congestion levels, accident likelihood, or traffic density across a map of the city, while time-series visualizations may illustrate how traffic metrics evolve over minutes, hours, days, or seasons.

In certain implementations, advanced features are provided in a premium version of the device. The premium device can include extended communication and analytics capabilities. In one implementation, the premium device is configured to communicate with other vehicles and with transportation management systems operated by entities such as state departments of transportation, for example, systems operated by Caltrans. The device can support multiple communication technologies to facilitate vehicle-to-vehicle (V2V) and broader vehicle-to-everything (V2X) connectivity.

In some implementations, the device supports Dedicated Short-Range Communications (DSRC) for V2V communication. DSRC is a wireless communication protocol designed for automotive use and operates in the 5.9 GHz band. The DSRC interface is configured to provide low-latency, reliable data exchange in vehicular environments and can support communication ranges on the order of hundreds of meters. In further implementations, the device supports Cellular Vehicle-to-Everything (C-V2X) 415 communication. The C-V2X subsystem relies on cellular networks, such as 4G LTE or 5G, and can support both network-based communications and direct V2V interactions. By leveraging existing cellular infrastructure, the C-V2X capability can provide extended range, higher bandwidth, and support for more complex data payloads, thereby enabling additional connected-car features and integration with transportation infrastructure.

In another implementation, the device supports Wi-Fi Direct, or an ad-hoc Wi-Fi mode, to enable peer-to-peer connections between devices without requiring a centralized access point. Wi-Fi Direct may use standard Wi-Fi hardware and can reduce cost and allow operation in environments lacking external infrastructure. The device may dynamically select among DSRC, C-V2X, Wi-Fi Direct, or other communication channels based on availability, regulatory constraints, or application requirements.

In some implementations, the premium device uses a microcomputer, such as a Raspberry Pi 4B+ or similar system-on-module, as a central processing unit. The microcomputer can be coupled to a powered USB hub to support multiple USB peripherals, including one or more DSRC transceivers and/or C-V2X modules. A V2X module can be selected from among commercially available DSRC or C-V2X units based on protocol compatibility, supported features, and regional regulatory requirements. DSRC transceivers can be chosen according to the communication standards and coverage needs of the intended deployment area. The device further includes one or more external antennas that are configured to enhance wireless communication performance. Antenna placement, orientation, and type can be selected to maximize range and signal quality for DSRC, C-V2X, Wi-Fi, or other supported communication technologies. In some implementations, the device additionally includes a high-accuracy Global Positioning System (GPS) module or other satellite-based positioning receiver. The GPS module is coupled to the microcomputer and is configured to provide precise location and timing information, which can be transmitted to other vehicles or roadside infrastructure for cooperative awareness and safety applications.

In additional implementations, the premium device provides driving profile generation and predictive insights for individual drivers and, in some cases, for families or groups of drivers associated with a common household or account. A driving profile can be defined as a structured collection of attributes derived from historical trip data, vehicle telemetry, sensor outputs, and contextual information. The attributes can be organized into several categories, including temporal attributes, location and route attributes, speed-related attributes, driving behavior attributes, and vehicle-specific attributes.

In one implementation, temporal attributes describe the timing characteristics of driving behavior. Examples include a time-of-day attribute, which may categorize trips into periods such as morning, afternoon, evening, or night, or may represent a specific hour of the day. Another attribute is day of the week, which can distinguish between weekdays and weekends or capture patterns on particular days. The system can also compute time spent driving per trip, expressed as a duration in minutes or hours, and can build a trip duration histogram that summarizes the distribution of trip lengths using statistical measures such as mean, minimum, maximum, and selected percentiles.

Location and route attributes characterize spatial behavior of the driver. In some implementations, the system records starting locations and destination locations for trips, which may be represented as categories (e.g., home, work, school, other place types) or as precise coordinates. A route complexity attribute can be computed, for example, based on length of a shortest path, the number of turns, or other measures of routing intricacy. The system can further identify typical routes, such as the top N most frequently used paths derived from trajectory data. In certain implementations, geo-fencing is utilized to determine how often a driver travels to or through specific geo-fenced regions, including home, workplace, or school zones. Area type attributes can categorize portions of a trip as urban, suburban, rural, or highway segments, and a driving location histogram can provide a statistical summary of the proportion of driving time spent in each type of area.

In further implementations, speed-related attributes are extracted to quantify velocity profiles and compliance behavior. An average speed attribute can represent the mean speed over a trip. Maximum speed captures the peak speed reached during a trip. A speeding events attribute can represent the number of instances where the driver's speed exceeded posted or inferred speed limits in a given time period or distance. A speed violations attribute can represent a normalized count of speed violations per unit distance or per trip. In some implementations, the system computes speeding event histograms 422 that summarize frequency and duration of time spent in various ranges above or below the speed limit, as well as speed distribution histograms that show the distribution of speeds maintained over trips or time intervals. Additional attributes can include an average deceleration rate that quantifies how quickly the driver typically slows down, and an acceleration histogram that provides a frequency distribution of acceleration levels over multiple trips.

Driving behavior attributes can further characterize qualitative aspects of driving style. In some cases, the system counts hard braking events, defined as instances of deceleration exceeding a threshold, and hard acceleration events, defined as acceleration beyond a threshold. A sharp turn histogram may be generated to summarize the number and severity (e.g., turning angle or lateral acceleration) of turns over trips. Lane change frequency can be calculated as a rate at which the driver changes lanes in a given distance or time. A tailgating count attribute can estimate how frequently the driver maintains a following distance shorter than a defined safe threshold. In certain implementations, the system computes a drowsiness score using signals from an in-vehicle camera or other sensors that monitor eye closure, head pose, or other indicators of fatigue. Similarly, a distraction score can be derived from head pose, gaze direction, mobile device interaction, or other signals, quantifying the frequency and intensity of distracted behavior.

In some implementations, the system further tracks counts of traffic rule violations, such as speeding, signal violations, and other infractions, normalized per unit time, distance, or number of trips. These various metrics can be combined to compute a safety score, which provides an overall indication of a driver's safety performance. A risk score can likewise be computed to indicate an overall risk profile, taking into account driving performance metrics, rule violation history, environmental context, and possibly external factors such as road conditions or traffic density.

In multi-vehicle households or fleet scenarios, the system can associate additional vehicle-specific attributes with each driver profile or with each vehicle used by a driver. These attributes can include vehicle make and model, vehicle type (such as sedan, sport utility vehicle, truck, or sports car), and vehicle age, which may be represented as a number of years or by a date of purchase or manufacture. The system can use these vehicle-specific attributes, in combination with the behavioral attributes described above, to refine the safety and risk scores or to tailor predictions and recommendations. For example, certain vehicle types or ages may correlate with different braking characteristics or crash outcomes, and the system can incorporate such information into its analyses.

In operation, the advanced features described above can be used to generate individualized and household-level driving profiles, provide predictive insights such as personalized risk forecasts or coaching recommendations, and to integrate these insights with the city traffic planning and V2X communication capabilities. In some implementations, these combined capabilities enable improved road safety, optimized traffic flow, and personalized driver feedback within a unified system architecture.

In some implementations, a device is configured to handle various edge cases relating to network connectivity and detection performance while maintaining reliable operation and data integrity. In one implementation, a basic version of the device is designed to operate without dependency on continuous external network connectivity. The basic device is configured to communicate with a user's mobile phone using a short-range wireless link, such as Bluetooth. The mobile phone serves as a relay between the device and a cloud database or external systems. During normal operation, the device can transmit collected data and event information to the mobile phone over the Bluetooth connection, and the phone forwards the received data to the cloud when wide-area connectivity is available.

In some implementations, when the Bluetooth connection between the device and the mobile phone is lost or interrupted, the device is configured to continue its sensing and processing operations while temporarily storing generated data in a local datastore. Upon detecting that the Bluetooth connection has been restored, the device can transmit the locally stored data to the mobile phone. In certain implementations, the device transmits data corresponding to events or measurements generated since a last successful dispatch, thereby avoiding redundant uploads and conserving bandwidth. On the mobile phone side, if Wi-Fi or cellular connectivity to the cloud is lost, the phone can locally cache data received from the device. When network connectivity from the phone to the cloud is restored, the phone automatically uploads the cached data to the cloud database or other designated external destination. This dual-layer buffering strategy allows the system to tolerate intermittent connectivity at both the device-to-phone and phone-to-cloud links while preserving a continuous data record.

In additional implementations, the device is configured to handle edge cases related to imperfect detection of traffic signs or other external markers. For example, the device may fail to detect traffic signs that are faded, damaged, partially obstructed, or otherwise degraded. In such cases, the device can log the missed detection event in its local datastore. The logged information may include sensor data, a timestamp, geolocation data, and contextual information that characterize the conditions under which the sign was not detected. Periodically, or when connectivity allows, the device uploads the missed-detection records from the local datastore to a cloud database. The cloud backend can aggregate such edge-case data from multiple devices to identify patterns, refine detection algorithms, update machine-learning models, and improve performance for future deployments. In this manner, the system uses edge-case conditions not only as operational contingencies but also as feedback inputs for continuous enhancement of detection accuracy and robustness.

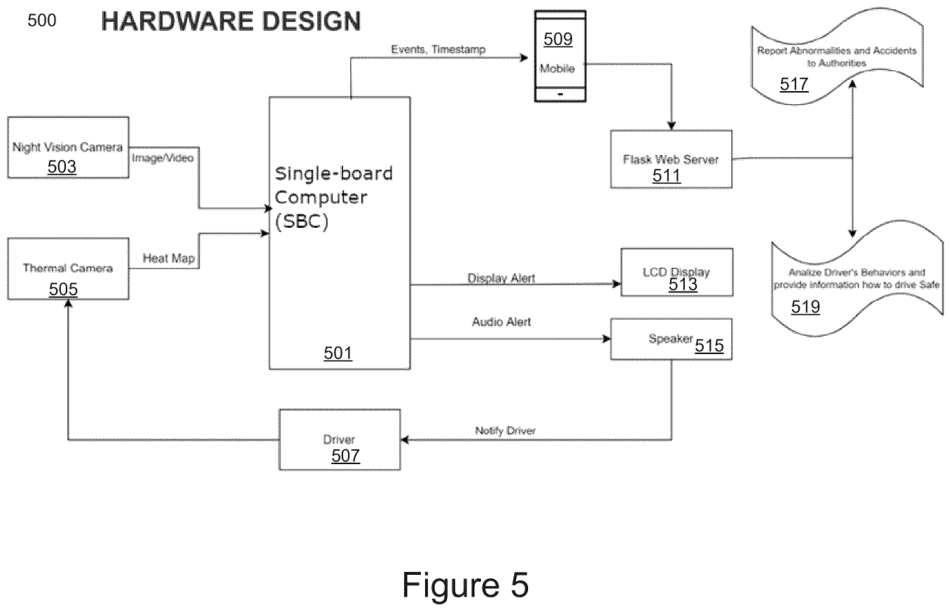

FIG. 5 illustrates an exemplary hardware design for an in-vehicle monitoring and alerting system 500. The system 500 includes a night vision camera 503, a thermal camera 505, a single-board computer 501, a driver 507, a mobile device 509, a Flask web server 511, an LCD display 513, and a speaker 515, which are operatively coupled as shown.

In the illustrated embodiment, the night vision camera 503 is configured to capture image or video data of the area surrounding the vehicle under low-light or nighttime conditions. The output of the night vision camera 503 is provided as an image/video signal to the single-board computer 501. The thermal camera 505 is configured to generate a heat map representing temperature distribution in the monitored scene. The thermal camera 505 supplies a heat map signal to the single-board computer 501 and, in some embodiments, may receive control signals from the single-board computer 501 to adjust operating parameters.

The single-board computer 501 executes object detection, driver monitoring, and alert-generation algorithms based on the image/video input from the night vision camera 503 and the heat map input from the thermal camera 505. When an event requiring driver notification is detected, the single-board computer 501 generates a display alert signal and an audio alert signal. The display alert signal is transmitted to the LCD display 513, which presents a visual alert to the driver 507, such as textual or graphical information describing the detected condition. The audio alert signal is transmitted to the speaker 515, which outputs an audible alert to notify the driver 507. The driver 507 thus receives multimodal alerts through the LCD display 513 and the speaker 515, as indicated by a notify driver path extending from the speaker 515 to the driver 507 and from the driver 507 back toward the thermal camera 505 to indicate a closed-loop interaction.

In addition to local alerts, the single-board computer 501 generates event data including event descriptors and timestamps and transmits this data to the mobile device 509. The communication between the single-board computer 501 and the mobile device 509 may be implemented using a short-range wireless protocol, such as Bluetooth, or other suitable communication link. The mobile device 509 is configured to forward the received event data to the Flask web server 511 over a wide-area network connection, for example via cellular or Wi-Fi data services.

The Flask web server 511 receives the event data from the mobile device 509 and performs remote analysis. In some embodiments, the Flask web server 511 is configured to report abnormalities and accidents to appropriate authorities based on analysis of the received data. The Flask web server 511 can also analyze the driver's behaviors and generate information describing how to drive safely, which may be made available to the driver 507 or other authorized users through web-based dashboards or mobile applications. Abnormalities and/or accidents may be reported to authorities 517. The behavior of the driver 507 may be analyzed 519 to provide information on safe driving to the driver 507.

Thus, as depicted in FIG. 5, the hardware design provides an integrated architecture in which the night vision camera 503 and thermal camera 505 supply sensor data to the single-board computer 501, which in turn generates local visual and audio alerts via the LCD display 513 and speaker 515, notifies the driver 507, and forwards event and timestamp information through the mobile device 509 to the Flask web server 511 for remote reporting and behavioral analysis

### Flow Architecture for Object Detection and Alert Generation

The sequence commences with an external event, specifically depicted as a pedestrian crossing the roadway in the path of the vehicle equipped with the inventive system. This external event represents any detectable object or situation requiring driver notification, including but not limited to pedestrians, vehicles, animals, obstacles, or changing traffic conditions.

### Device Processing Sequence

Upon detection of the external event, the device executes a series of coordinated actions as follows:
General sequence
Data Flow Architecture for Object Detection and Alert Generation

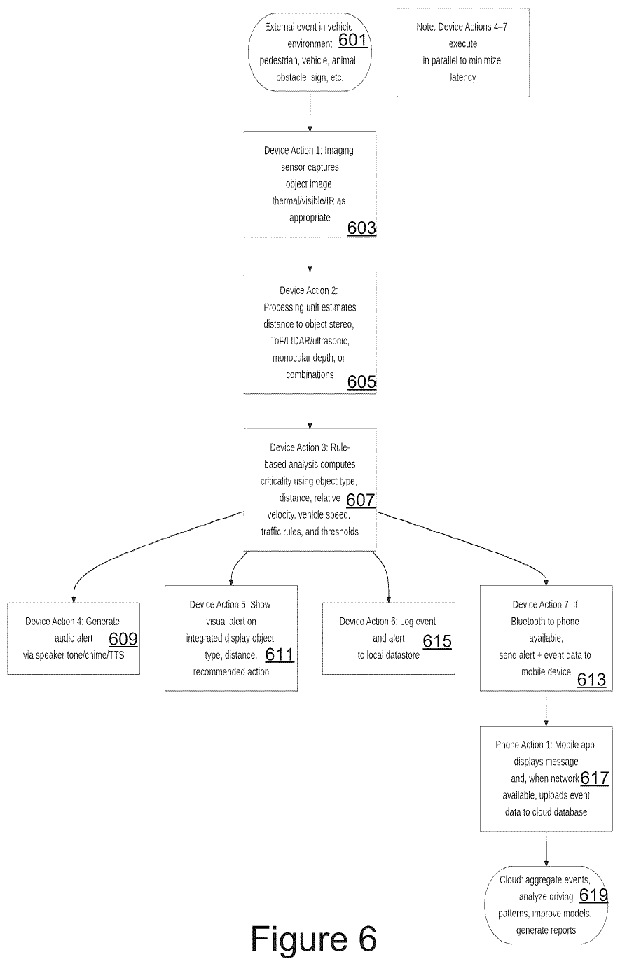

FIG. 6 illustrates an exemplary data flow sequence from initial image capture through object detection, classification, rule-based analysis, and multi-channel alert generation, as implemented in the present invention. The figure depicts the complete processing pipeline triggered by an external event and the subsequent actions executed by the device and associated mobile communication apparatus.

### External Event Initiation

The architecture further demonstrates the distributed processing approach, wherein real-time detection and immediate alerting occur on the edge device with computational constraints, while resource-intensive historical analysis and model retraining operations are offloaded to mobile devices and cloud computing infrastructure where computational resources are abundant.

The sequence depicted in FIG. 6 demonstrates the multi-modal alert architecture of the present invention, wherein a single detected event triggers coordinated responses across multiple output channels (audio, visual, local storage, mobile device, and cloud services) with appropriate prioritization and timing to ensure driver awareness while maintaining comprehensive data logging for analytical purposes. The parallel execution of Device Actions 4 through 7 ensures minimal latency between event detection and driver notification, with the most time-critical audio and visual alerts generated without waiting for completion of data logging or wireless transmission operations.

FIG. 6a illustrates an exemplary data flow sequence from initial image capture through object detection, classification, rule-based analysis, and multi-channel alert generation, as implemented in the present invention. The figure depicts the complete processing pipeline 600 triggered by an external event and the subsequent actions executed by the device and associated mobile communication apparatus.

This exemplary embodiment illustrates the system's operation for object detection in general; however, the identical data flow architecture applies to any specific object type detection including pedestrians, vehicles, animals, traffic signs, obstacles, fire, or driver behavior monitoring alerts, with variations only in the specific content of generated messages and criticality assessment parameters.

Upon detection of the external event, the device executes a series of coordinated actions as follows:

The system's imaging sensor 603 captures image data of the detected object. The imaging capability may utilize thermal imaging for detection under low-light conditions, visible-light imaging for daytime operation, infrared imaging for enhanced object contrast, or combinations thereof depending on environmental conditions and sensor availability. The imaging sensor selects the appropriate imaging modality based on ambient light levels, weather conditions, and object detection requirements.

The processing unit 605 calculates the distance between the vehicle and the detected object utilizing distance estimation algorithms. Distance calculation may be performed through stereoscopic imaging analysis, time-of-flight measurements from dedicated ranging sensors (such as LIDAR or ultrasonic sensors), monocular depth estimation neural networks trained to infer distance from single camera images, or combinations of multiple distance estimation methodologies to improve accuracy and reliability.

The rule-based analysis algorithm generates an alert message based on the criticality of the detected event 607. Critical determination incorporates multiple factors including object classification (e.g., pedestrian, vehicle, animal, stationary obstacle, traffic sign), calculated distance, relative velocity between vehicle and object, current vehicle speed, detected traffic signs and applicable regulations, and user-configured threshold parameters. The algorithm assigns a priority level to the event determining the urgency and modality of subsequent alerts.

Based on the criticality assessment, the device generates an audible alert through the integrated speaker component 609. The audible alert may comprise a tone, chime, verbal warning message synthesized through text-to-speech processing, or pre-recorded audio notifications, with volume and repetition characteristics determined by the assigned priority level.

Simultaneously with or subsequent to audio notification, the device displays a visual alert message on the integrated display monitor 611. The visual message provides textual and/or graphical information regarding the detected event, including object type, distance, and recommended driver action. The display formatting, duration, and prominence are adjusted according to event criticality.

The device records the event and associated alert message in the local datastore residing on non-volatile storage media integrated within or connected to the device 615. This logging function maintains a historical record of detected events enabling subsequent analysis of driving patterns, system performance evaluation, and evidentiary documentation in the event of incidents.

When Bluetooth communication with a paired mobile device 613 is enabled and an active connection is established, the device transmits the alert message and associated event data to the mobile device via the Bluetooth communication protocol. This transmission occurs asynchronously with other alert modalities, ensuring that communication delays do not impede time-critical audio and visual notifications to the driver.

Upon receiving event data via Bluetooth connection, the mobile device displays the message through its native display interface, providing an additional alert channel and enabling passengers or the driver 617 (when the vehicle is not in motion) to review detailed event information. The mobile application executing on the phone is further configured to transmit the message and associated data to a cloud database system via cellular or WiFi data connection when such connectivity is available. This cloud upload enables historical analysis 619 of driving patterns, aggregation of traffic event data across multiple users for traffic condition mapping, continuous improvement of detection algorithms through analysis of recorded events, and generation of comprehensive safety reports accessible through web-based dashboard interfaces.

The sequence depicted in FIG. 6 demonstrates the multi-modal alert architecture of the present invention, wherein a single detected event triggers coordinated responses across multiple output channels (audio, visual, local storage, mobile device, and cloud services) with appropriate prioritization and timing to ensure driver awareness while maintaining comprehensive data logging for analytical purposes. The parallel execution of Device Actions 4 through 7 ensures minimal latency between event detection and driver notification, with the most time-critical audio and visual alerts generated without waiting for completion of data logging or wireless transmission operations. The architecture further demonstrates the distributed processing approach, wherein real-time detection and immediate alerting occur on the edge device with computational constraints, while resource-intensive historical analysis and model retraining operations are offloaded to mobile devices and cloud computing infrastructure where computational resources are abundant. This exemplary embodiment illustrates the system's operation for object detection in general; however, the identical data flow architecture applies to any specific object type detection including pedestrians, vehicles, animals, traffic signs, obstacles, fire, or driver behavior monitoring alerts, with variations only in the specific content of generated messages and criticality assessment parameters.

### Pedestrian Detection Sequence

The sequence commences with an external event 701 representing any detectable object or situation requiring driver notification, including but not limited to pedestrians, vehicles, animals, obstacles, traffic signs, or changing traffic conditions within the vehicle's surrounding environment.

The system's imaging sensor 703 captures thermal image data of the detected object. In some implementations the detected object is a pedestrian crossing a road. The thermal imaging capability enables detection under low-light conditions and provides enhanced contrast for pedestrian detection compared to conventional visible-light imaging alone. Alternative implementations may utilize visible-light imaging, infrared imaging, or combinations thereof depending on environmental conditions and sensor availability.

The processing unit 705 calculates the distance between the vehicle and the detected object 601 utilizing distance estimation algorithms. Distance calculation may be performed through stereoscopic imaging analysis, time-of-flight measurements from dedicated ranging sensors (such as LIDAR or ultrasonic sensors), monocular depth estimation neural networks trained to infer distance from single camera images, or combinations of multiple distance estimation methodologies to improve accuracy and reliability.

The rule-based analysis algorithm generates an alert message 707 based on the criticality of the detected event. Critical determination incorporates multiple factors including object classification (e.g., pedestrian, vehicle, stationary obstacle), calculated distance, relative velocity between vehicle and object, current vehicle speed, detected traffic signs and applicable regulations, and user-configured threshold parameters. The algorithm assigns a priority level to the event determining the urgency and modality of subsequent alerts.

Based on the critical assessment, the device generates an audible alert 709 through the integrated speaker component. The audible alert may comprise a tone, chime, verbal warning message synthesized through text-to-speech processing, or pre-recorded audio notifications, with volume and repetition characteristics determined by the assigned priority level.

Simultaneously with or subsequent to audio notification, the device displays a visual alert message on the integrated display monitor 711. The visual message provides textual and/or graphical information regarding the detected event, including object type, distance, and recommended driver action. The display formatting, duration, and prominence are adjusted according to event criticality.

The device records the event and associated alert message in the local datastore 715 residing on non-volatile storage media integrated within or connected to the device. This logging function maintains a historical record of detected events enabling subsequent analysis of driving patterns, system performance evaluation, and evidentiary documentation in the event of incidents.

When Bluetooth communication with a paired mobile device 713 is enabled and an active connection is established, the device transmits the alert message and associated event data to the mobile device via the Bluetooth communication protocol. This transmission occurs asynchronously with other alert modalities, ensuring that communication delays do not impede time-critical audio and visual notifications to the driver.

Upon receiving event data via Bluetooth connection, the mobile device 713 displays the message through its native display interface, providing an additional alert channel and enabling passengers or the driver 617 (when the vehicle is not in motion) to review detailed event information. The mobile application executing on the phone is further configured to transmit the message and associated data to a cloud database system via cellular or WiFi data connection when such connectivity is available. This cloud upload enables historical analysis of driving patterns, aggregation of traffic event data across multiple users for traffic condition mapping, continuous improvement of detection algorithms through analysis of recorded events, and generation of comprehensive safety reports accessible through web-based dashboard interfaces.

### Flow Chart: Traffic Sign Detection and Continuous Model Improvement

### Start

Step 801: Create a large-scale traffic sign dataset compliant with United States traffic signage standards by collecting and labeling images representing diverse traffic sign categories encountered in real-world driving environments.

Step 802: Preprocess the traffic sign dataset using a data preparation pipeline that applies augmentation techniques, including simulation of varying lighting conditions, weather effects, and viewing angles.

Step 803: Train one or more traffic sign detection models using the preprocessed dataset, wherein the models employ an ensemble detection framework comprising an Object Size Detector (OSD), a Multi-Stage Detector (MSD), and a Fully Convolutional One-Stage (FCOS) detector.

Step 804: Evaluate the trained ensemble detection models to verify that detection accuracy exceeds a predefined threshold and that inference latency remains below a real-time performance threshold suitable for vehicular applications.

Step 805: Deploy the trained traffic sign detection models to vehicle-mounted devices for real-time inference during driving operations.

Step 806: Detect traffic signs in real time using the deployed models, including both recognized traffic signs and unclassified sign-like objects encountered during vehicle operation.

Step 807: Capture and transmit detection data, including images, metadata, and classification results, from deployed devices to cloud-based storage systems.

Step 808: Aggregate detection data in cloud databases to form an expanded dataset comprising new instances of known traffic sign types and previously unseen traffic sign types.

Step 809: Periodically retrain and refine the traffic sign detection models in a cloud computing environment using the aggregated dataset.

Step 810: Evaluate retrained models to determine whether updated performance metrics demonstrate improvement over previously deployed models.

Step 811: evaluate the performance metrics. If the metrics are not improved return to step 809 to retrain and refine the traffic sign detection models in a cloud computing environment using the aggregated dataset. If the metrics are improved move to step 812.

Step 812: Distribute updated and improved models from the cloud computing environment to deployed vehicle-mounted devices.

### Method for Continuous Model Improvement Through Selective Image Upload and Retraining

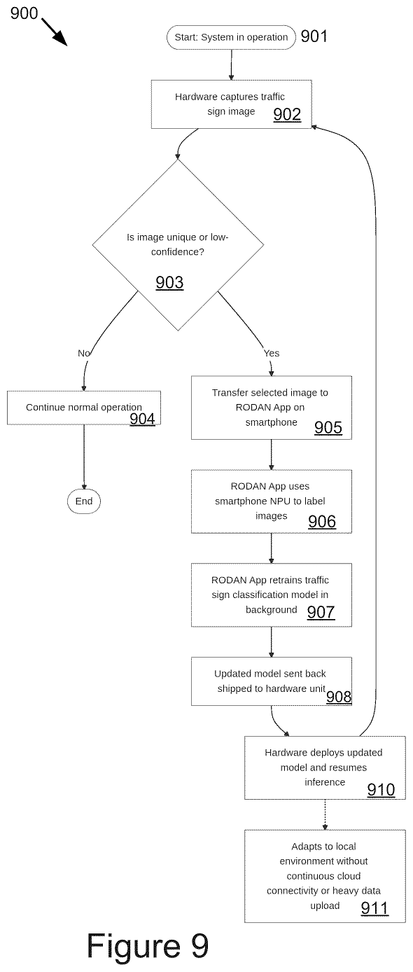

FIG. 9 illustrates a flowchart depicting an exemplary method 900 for achieving continuous improvement of machine learning model accuracy through selective capture, transmission, and cloud-based retraining of traffic sign detection models. The method implements an intelligent filtering mechanism that prioritizes novel or low-confidence detections for model enhancement while minimizing unnecessary data transmission and computational overhead.

### Method Overview and Initialization

The method commences at step 901 with the system in normal operation mode. At this initialization step, the vehicle-mounted hardware device is powered on, machine learning models are loaded into memory, imaging sensors are activated, and the system begins real-time monitoring of the vehicle's surrounding environment. The system operates continuously during vehicle operation, executing the subsequent steps in a repeated loop as traffic signs are encountered.

### Image Capture and Initial Processing

At step 902, the hardware imaging sensors capture a traffic sign image from the vehicle's surrounding environment. The image capture occurs during normal system operation as part of the continuous traffic sign detection functionality described previously. The captured image undergoes preprocessing including color normalization, resolution adjustment, and enhancement operations to optimize image quality for subsequent analysis. The image data is temporarily stored in device memory for evaluation in subsequent method steps.

### Uniqueness and Confidence Assessment

Following image capture, the method proceeds to step 903, wherein the system evaluates whether the captured image represents a unique traffic sign not previously encountered or whether the detection exhibits low confidence levels requiring additional training data. This evaluation step implements multiple assessment criteria:

Uniqueness Determination: The system compares the captured traffic sign image against a database of previously detected sign types stored in local memory or accessible via cloud connectivity. If the detected sign does not match any known sign classifications in the training dataset, or if the sign represents a known type but captured under novel environmental conditions (unusual lighting, weather, viewing angle, or partial occlusion), the image is classified as unique.

Confidence Analysis: The machine learning model generates a confidence score indicating the certainty of its classification decision for the detected traffic sign. If the confidence score falls below a predetermined threshold (for example, below 85% confidence), the detection is flagged as low-confidence, indicating the model would benefit from additional training examples of this sign type or presentation condition.

The step 903 incorporates both uniqueness and confidence criteria, wherein an affirmative determination results if either condition is met (unique sign OR low confidence), ensuring comprehensive coverage of scenarios beneficial for model improvement.

### Conditional Processing Branches

The method branches based on the determination made at step 903:

### Negative Branch: Standard Operation Continuation

If the determination at step 903 is negative—meaning the captured image represents a previously encountered traffic sign type detected with high confidence—the method proceeds to step 904. At this step, the system continues normal operation without uploading the captured image to cloud storage. The image may be discarded from memory or stored locally for short-term logging purposes, but is not transmitted to remote servers for model retraining. This filtering mechanism substantially reduces data transmission bandwidth requirements and cloud storage utilization by avoiding redundant uploads of common, well-recognized traffic signs.

Following step 904, the method returns to step 902 to capture the next traffic sign image as the vehicle continues operation, thereby establishing a continuous monitoring loop. Eventually, the method terminates at the “End” state when the vehicle is powered off or the system is otherwise deactivated.

### Affirmative Branch: Cloud Upload and Retraining Pipeline

If the determination at step 903 is affirmative—meaning the captured image is unique or exhibits low detection confidence—the method proceeds to step 905 to initiate the cloud-based model improvement pipeline.

### Mobile Application Integration and Image Transfer

At step 905, the vehicle-mounted hardware device transfers the selected traffic sign image to a mobile application (“RODAN App”) executing on the user's smartphone. The image transfer occurs via the Bluetooth communication connection established between the vehicle-mounted device and the paired mobile device, utilizing the same wireless communication pathway employed for alert message transmission described in previous figures.

The transfer to the mobile application serves multiple purposes: (1) offloading cloud connectivity requirements from the resource-constrained vehicle hardware to the more capable smartphone, (2) enabling image upload via cellular data networks when the vehicle is in motion and WiFi connectivity is unavailable, and (3) providing user visibility into the continuous learning process through mobile application interfaces.

### Smartphone-Based Image Labeling

At step 906, the RODAN mobile application utilizes the smartphone's neural processing unit (NPU) or other hardware acceleration capabilities to perform on-device image labeling. The smartphone executes a lightweight image classification model that assigns preliminary labels to the traffic sign image, identifying the sign type, geometric characteristics, color scheme, and other relevant attributes.

The use of smartphone NPU capabilities for this labeling step provides several advantages: (1) computational processing is offloaded from cloud servers, reducing server load and processing costs, (2) labeling occurs locally without requiring immediate cloud connectivity, allowing the process to continue even during temporary network unavailability, and (3) modern smartphone processors provide sufficient computational power for this classification task without significantly impacting battery life or user experience.

The preliminary labels generated at step 906 serve as metadata annotations accompanying the image when uploaded to cloud storage, facilitating subsequent automated processing and quality control operations in the cloud environment.

### Background Model Retraining

At step 907, the RODAN mobile application initiates background retraining of the traffic sign classification model using cloud-based machine learning infrastructure. The application uploads the labeled image to cloud storage servers where it is incorporated into the training dataset. Cloud-based training processes then retrain or fine-tune the existing traffic sign detection model using the augmented dataset that now includes the newly uploaded image.

The retraining process occurs asynchronously in the background without requiring user interaction or system downtime. Cloud computing resources execute the computationally intensive training algorithms, which may include gradient descent optimization, backpropagation through neural network layers, validation testing against held-out test datasets, and performance metric evaluation to ensure the updated model achieves improved or maintained accuracy levels.

The background execution model ensures that model improvement occurs continuously without interrupting system operation. Multiple images uploaded from numerous deployed devices across different geographic regions are aggregated in the cloud training pipeline, enabling the system to learn from diverse real-world traffic sign presentations encountered across the entire user population.

### Model Distribution to Hardware

At step 908, upon completion of the retraining process and validation that the updated model meets performance criteria, the updated machine learning model is packaged and transmitted back to the vehicle-mounted hardware unit. The model distribution occurs via the reverse communication pathway: from cloud servers to the mobile application via cellular or WiFi data connection, and then from the mobile application to the vehicle-mounted device via Bluetooth connection.

Alternatively, in embodiments where the vehicle-mounted hardware possesses independent internet connectivity (such as through integrated cellular modems or when the vehicle is parked within range of the user's home WiFi network), the updated model may be transmitted directly from cloud servers to the hardware device without mobile application intermediation.

The model packaging ensures compatibility with the hardware device's operating system, framework requirements (such as TensorFlow Lite format), and quantization specifications optimized for edge computing execution on resource-constrained processors.

### Model Deployment and Inference Resumption

At step 910, the vehicle-mounted hardware device deploys the updated machine learning model, replacing the previous model version with the newly trained model that incorporates knowledge gained from the recently uploaded traffic sign images. The deployment process includes loading the new model weights into memory, initializing model inference engines, and performing validation checks to ensure the model functions correctly on the target hardware.

Following successful deployment, the device resumes normal inference operations using the updated model. The system now possesses enhanced capability to recognize the previously unique or low-confidence traffic sign types that triggered the upload and retraining cycle, demonstrating measurable improvement in detection accuracy resulting directly from the continuous learning pipeline.

The hardware continues monitoring for additional traffic signs, returning to step 902 to capture subsequent images and repeating the evaluation and selective upload process described above.

### Adaptive Local Operation

At step 911, the system implements adaptive behavior to accommodate environments with limited or absent cloud connectivity. The method adapts to local environmental constraints by continuing traffic sign detection operations even when continuous cloud connectivity is unavailable or when network bandwidth limitations would make heavy data uploads impractical.

In scenarios where cloud connectivity is intermittent, the system queues captured unique or low-confidence images in local storage for upload when connectivity is restored, ensuring that valuable training data is not lost due to temporary network unavailability. The system may implement intelligent upload scheduling that prioritizes WiFi connections over cellular data to minimize user data plan consumption, and may compress or downsample images when bandwidth is constrained while preserving sufficient image quality for model training purposes.

The adaptive operation ensures the system remains functional and continues providing traffic sign detection capabilities even in rural areas, tunnels, or other locations where cellular coverage may be limited, while still participating in the continuous improvement ecosystem when connectivity permits.

### Continuous Improvement Cycle

The method depicted in FIG. 9 establishes a closed-loop continuous improvement system wherein deployed hardware devices serve simultaneously as operational safety systems and as distributed data collection nodes feeding a centralized model improvement pipeline. Each unique or challenging traffic sign detection encountered in real-world usage automatically contributes to enhanced model performance, with improvements distributed back to all deployed devices through the model update mechanism.

This architecture enables the system to continuously adapt to evolving traffic sign standards, regional sign variations, new sign types introduced by transportation authorities, and challenging environmental conditions encountered across diverse geographic deployments. The selective upload mechanism ensures efficiency by focusing computational and bandwidth resources on genuinely novel or challenging cases rather than redundantly processing common, well-recognized sign types.

The method thereby achieves progressive accuracy improvement over the system lifecycle without requiring manual dataset curation, centralized data collection efforts, or scheduled training cycles, representing a substantial advancement over static machine learning deployments that do not incorporate field feedback into ongoing model refinement.

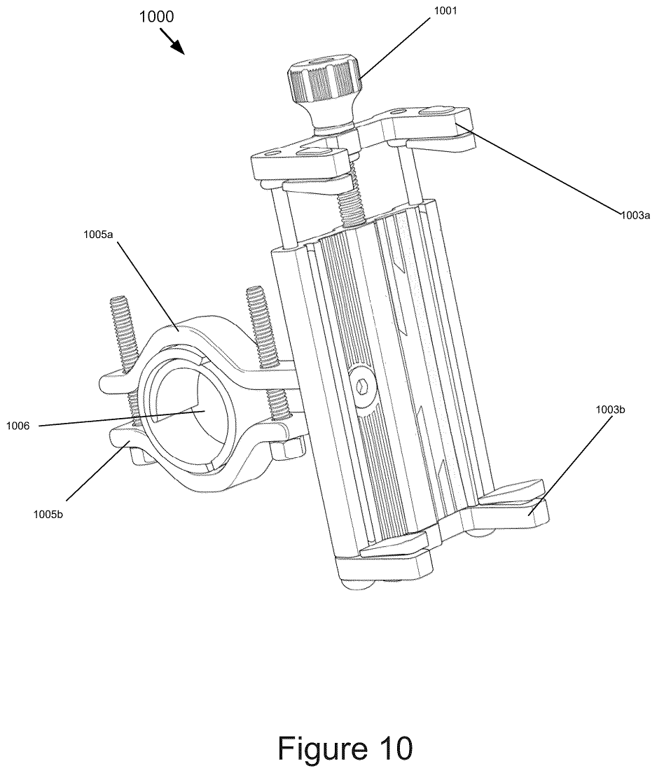

Referring to the FIG. 10, an adjustable mounting apparatus 1000 for a mobile electronic device or a portable accident detection device is disclosed. The mounting apparatus is designed to securely retain a device, such as a smartphone, and provide a stable interface for attachment to a cylindrical member, such as a bicycle or motorcycle handlebar.

As shown in the figures, the mounting apparatus comprises a main body configured to support the rear surface of a mobile device. The main body features a series of longitudinal grooves or ridges to enhance structural rigidity and provide a high-friction interface with the device.

The apparatus includes a primary adjustment mechanism 1001 comprising a threaded screw and a rotatable adjustment knob. Rotation of the adjustment knob translates the upper retention bracket along a pair of parallel guide rods, allowing the apparatus to expand or contract to accommodate devices of varying vertical dimensions. The upper retention bracket and a pair of fixed lower retention feet define the boundaries of the device seating area.

To protect the mobile electronic device from mechanical shock and scratching, the upper retention bracket 1003a and lower retention feet 1003b are equipped with protective padding, which may be composed of silicone, rubber, or a similar elastomeric material.

Extending from the rear or lateral side of the main body is a clamping assembly 1004 configured for attachment to a supporting structure. The clamping assembly consists of a pair of arcuate clamping members 1005a and 1005b defining a central aperture 1006. The diameter of this aperture is adjustable via a pair of parallel threaded fasteners (bolts) and corresponding nuts.

In operation, the arcuate clamping members are placed around a handlebar or similar structure, and the threaded fasteners are tightened to apply compressive force, thereby rotationally and transitionally fixing the mounting apparatus to the support structure. The main body is coupled to the clamping assembly via a central pivot point, which may include a hexagonal socket or similar fastener to allow for angular orientation adjustments of the device relative to the user.

The mounting apparatus is preferably constructed from high-strength materials, such as an aluminum alloy or reinforced polymer, to ensure a robust build capable of withstanding high-precision detail and vibration during use.

### Mobile Application User Interface for Real-Time Alert Display

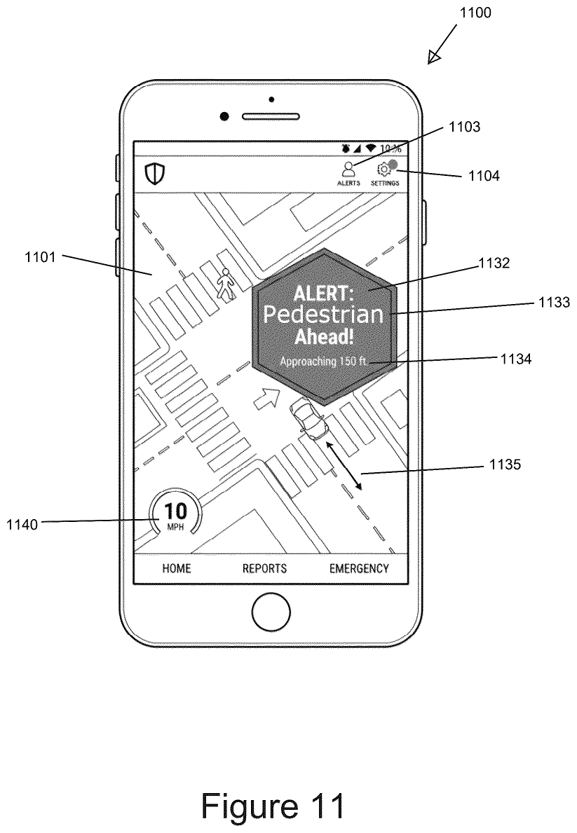

FIG. 11 illustrates an exemplary mobile application user interface 1100 executing on a mobile communication device and displaying real-time alert information received from the vehicle-mounted safety monitoring system via Bluetooth communication protocol. The figure depicts the graphical user interface elements, navigational components, and alert presentation format as rendered on a smartphone display screen.

### Mobile Device Hardware

The mobile application interface is displayed on a smartphone device 1101 comprising a touchscreen display 1102, hardware buttons disposed along the device edges for power and volume control, and standard smartphone components including speaker ports and front-facing camera. The touchscreen display 1102 serves as both the output mechanism for visual information and the input mechanism for user interaction through touch gestures.

### Application Header Section

At the top of the display interface, a header bar presents the application primary navigation controls. The shield iconography communicates the protective and safety-oriented nature of the application to users.

The right portion of the header bar contains two icon-based navigation buttons:

An alerts button 1103 represented by a bell icon with accompanying “ALERTS” label, providing access to a historical log of received alerts and notification management settings

A settings button 1104 represented by a gear icon with accompanying “SETTINGS” label, providing access to application configuration options, user preferences, threshold adjustments, and system parameters

The header bar further displays standard smartphone status indicators 1115 including cellular signal strength, WiFi connectivity status, battery level (shown as 10%), and current time, conforming to conventional mobile operating system interface guidelines.

### Map Display Region

The central and largest portion of the display interface comprises a map display 1120 providing a graphical representation of the vehicle's current location and surrounding geographic context. The map view presents a stylized overhead perspective of roadways, intersections, buildings, and other geographic features relevant to navigation and situational awareness.

The map display employs conventional cartographic symbols including:
Solid lines representing paved roadways and streets
Dashed lines representing lane boundaries and road markings
Rectangular shapes representing buildings and structures
Crosswalk markings depicted with parallel lines indicating pedestrian crossing zones
Directional arrows showing vehicle travel direction and suggested navigation paths

The map view dynamically updates in real-time as the vehicle moves, maintaining the vehicle's current position centered or prominently positioned within the display area. The map may be rendered using stored cartographic data, real-time GPS positioning, or map tile data retrieved from remote mapping services via cellular or WiFi data connections.

### Alert Notification Overlay

Superimposed over the map display, a alert notification overlay 1130 presents time-critical safety information to the user. The alert notification comprises a hexagonal overlay shape 1131 with dark background coloring to ensure high contrast and visibility against the underlying map imagery.

The alert notification contains multiple informational components arranged hierarchically by importance:

Alert Header 1132: The word “ALERT:” displayed in bold, capital letters at the top of the notification element, immediately drawing user attention to the critical nature of the message.

Object Type Identification 1133: A primary descriptor identifying the type of detected object or hazard, in this exemplary embodiment displaying “Pedestrian Ahead!” to indicate a pedestrian has been detected in the vehicle's path. Alternative embodiments may display different object classifications such as “Vehicle Ahead!”, “Obstacle Detected!”, “Traffic Sign: Stop”, “Animal on Road!”, or other situation-specific descriptions.

Distance Information 1134: A secondary descriptor providing quantitative distance information, in this embodiment displaying “Approaching 150 ft.” to inform the user of the proximity of the detected hazard. The distance value updates dynamically as the relative position between vehicle and object changes, providing real-time situational awareness.

The hexagonal shape of the alert overlay provides a distinctive geometric form easily distinguished from rectangular interface elements, ensuring the alert is immediately recognizable even in a driver's peripheral vision. The shape selection further suggests caution and warning, consistent with conventional hazard signage geometries.

A directional indicator 1135 in the form of an arrow overlaid on the map points toward the location of the detected object, providing spatial orientation to help the user quickly locate the hazard within their field of view. In this exemplary embodiment, the arrow points toward a pedestrian icon 1136 displayed on the map at the location where the pedestrian was detected, providing visual correlation between the abstract alert notification and the concrete map representation.

### Speed Display Indicator

A circular speed indicator 1140 is positioned in the lower-left region of the display interface, presenting the vehicle's current speed. The indicator displays a numeric speed value, shown as “10” in this embodiment, along with a unit designation indicating “MPH” (miles per hour). Alternative embodiments may display speed in kilometers per hour (KPH) or other velocity units based on user preferences or regional standards.

The speed indicator provides contextual information enabling the user to assess the urgency of alerts based on current vehicle velocity. For example, a pedestrian detected at 150 feet poses different levels of concern when traveling at 10 MPH versus 60 MPH, and the combination of alert and speed information enables informed driver response.

### Navigation Button Bar

The bottom edge of the display interface contains a navigation button bar providing access to primary application functions through three equally-sized buttons arranged horizontally:

Home Button: Labeled “HOME”, this button returns the user to the main dashboard view depicted in FIG. 11, showing the map display with real-time alerts. This serves as the default and primary application screen during active driving.

Reports Button 1152: Labeled “REPORTS”, this button navigates to a reports view (not shown) where users can access historical driving data, review past alerts, analyze driving patterns, and generate safety summary reports based on logged event data.

Emergency Button: Labeled “EMERGENCY”, this button provides immediate access to emergency functions such as one-touch emergency services contact, crash detection notification, or automated emergency alert transmission to pre-configured emergency contacts.

The three-button navigation structure provides clear, touch-friendly targets suitable for operation even under driver distraction or stress conditions, with button labels in capital letters ensuring readability at a glance.

### User Interaction and Alert Workflow

The mobile application interface depicted in FIG. 11 represents the visual presentation of alert data transmitted from the vehicle-mounted device to the mobile phone via Bluetooth connection, as described in Phone Action-1 of the data flow sequence. When the vehicle-mounted device detects an object and generates an alert (Device Actions 1-7 ), the mobile application receives the alert data wirelessly and immediately renders the alert notification overlay 1130 on the map display, simultaneously providing visual information and optionally generating haptic feedback or supplementary audio alerts through the phone's speakers.

The user may dismiss alerts through touch gestures such as tapping or swiping the alert overlay, or alerts may automatically dismiss after a predetermined time period or when the detected object is no longer in proximity. The application maintains a log of all received alerts accessible through the alerts button 1113, enabling post-drive review and analysis.

The mobile application further implements the cloud connectivity function described in the data flow architecture, automatically transmitting alert data and associated driving information to cloud database systems when cellular or WiFi connectivity is available, thereby contributing to the aggregated safety analytics and continuous model improvement capabilities of the overall system.

### Display Adaptability

While FIG. 11 depicts a graphical user interface displaying a specific alert scenario involving pedestrian detection, the mobile application interface adaptively presents alerts for any type of detected object or traffic situation. The alert notification overlay 1130 dynamically updates its content based on the object classification, distance, and criticality level transmitted from the vehicle-mounted device, ensuring appropriate information display for diverse traffic scenarios including vehicle detection, animal hazards, obstacle warnings, traffic sign notifications, and driver behavior alerts.

The map display 1120 similarly adapts to show relevant contextual information based on alert type, with iconographic representations of detected objects positioned at their geographic locations to provide spatial context supplementing the textual alert descriptions.

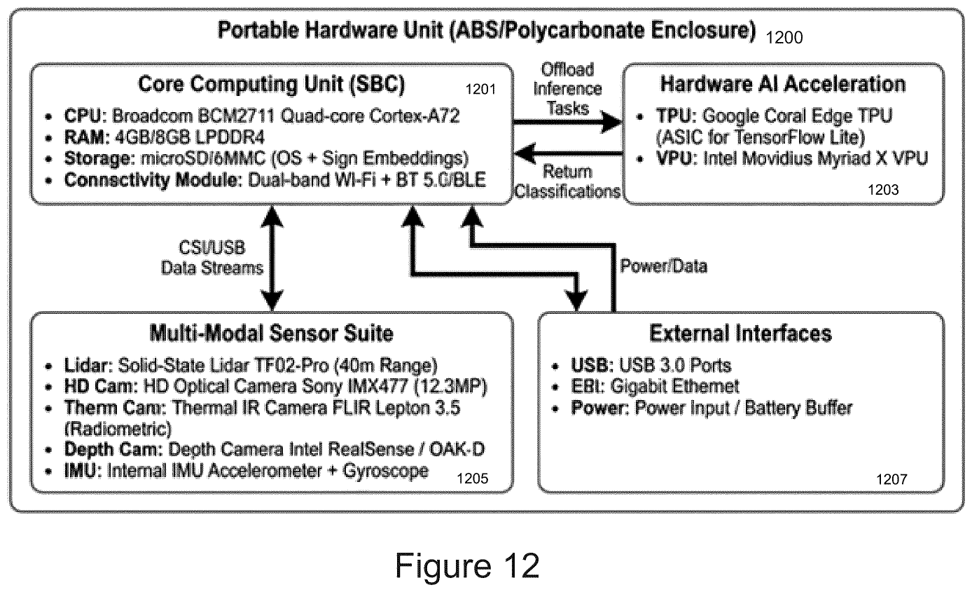

Other implementations are described in the following implementations and figures. Referring to FIG. 12, a schematic representation of a portable hazard detection apparatus is shown in accordance with one embodiment of the present disclosure. The apparatus comprises a portable hardware unit 1200 contained within a ruggedized housing configured for temporary and modular attachment to a variety of vehicle types. At the heart of the portable hardware unit 1200 is a core computing unit 1200, which manages the primary logic, data flow, and localized model evolution processes.

Operatively coupled to the core computing unit 1200 is a multi-modal sensor suite 1203. The multi-modal sensor suite 1203 includes a plurality of spatial and visual sensors, such as an optical camera, a solid-state LiDAR sensor, and a thermal infrared camera, designed to capture environmental data in a 360-degree field of view. To process this high-bandwidth data in real-time, the apparatus includes a dedicated hardware AI acceleration 1205 module. This hardware AI acceleration 1205 enables high-speed object inference and classification, allowing the system to identify potential hazards and traffic violations with minimal latency.

Furthermore, the portable hardware unit 1200 is equipped with a plurality of external interfaces 1207. These external interfaces 1207 facilitate high-speed local wireless communication with a paired mobile device for model updates and digital twin synchronization, as well as providing physical or wireless connectivity to vehicle-to-everything (V2X) infrastructure, such as DSRC transceivers operating in the 5.9 GHz band.

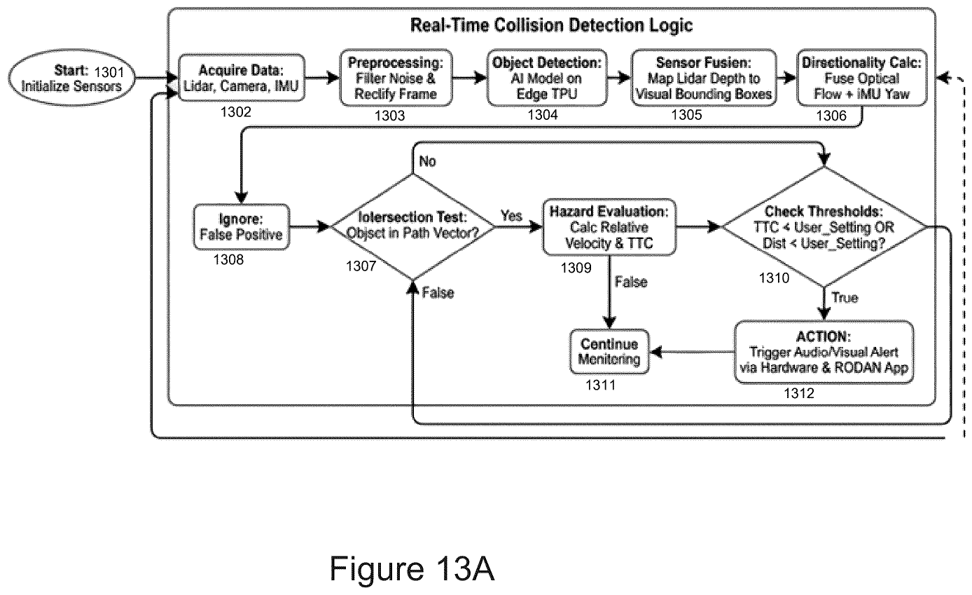

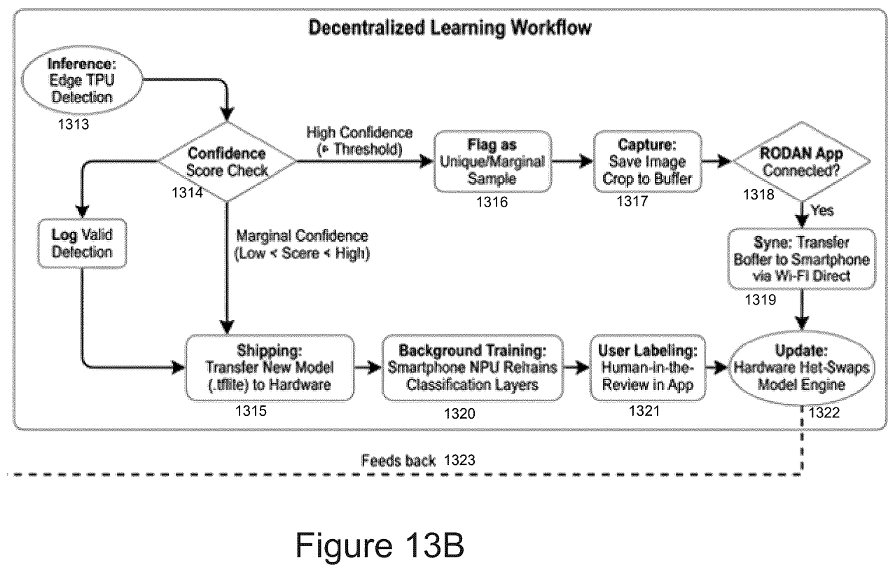

FIG. 13 illustrates an embodiment of a real-time collision detection logic flow. The process begins at a start node 1301 in which the system initializes sensors. From the start node 1301, the system proceeds to an acquire-data step 1302, during which sensor data is collected from a LiDAR, a camera, and an inertial measurement unit (IMU). The acquired data is then subjected to a preprocessing step 1303 that filters noise and rectifies image frames. An object-detection step 1304 executes an AI model on an edge tensor processing unit to identify objects within the preprocessed data. A sensor-fusion step 1305 maps LiDAR depth measurements to corresponding visual bounding boxes. A directionality-calculation step 1306 fuses optical-flow data with IMU yaw information to determine object motion relative to the vehicle. An intersection-test decision 1307 determines whether a detected object lies within a path vector of the vehicle; if not, the detection is treated as a false positive and ignored at step 1308, and monitoring continues. If the object is within the path vector, a hazard-evaluation step 1309 calculates relative velocity and time-to-collision (TTC). A threshold-checking decision 1310 compares the calculated TTC and distance against user-defined settings; if the TTC is not less than a user threshold and the distance is not below a user threshold, the logic returns to a continue-monitoring step 1311. If either the TTC or distance satisfies the criticality condition, an action step 1312 is executed in which the system triggers an audio and/or visual alert via hardware and an associated RODAN application.

FIG. 13 is a flow diagram illustrating a decentralized learning workflow for localized machine learning model evolution. The process initiates at step 1313, where an initial inference is performed using an edge TPU detection module. Following detection, a confidence score check is executed at step 1314. If the detection is validated as a marginal confidence (low<score<high), the logic proceeds to a shipping phase at step 1315, wherein a new model (.tflite) is transferred to the hardware.

Alternatively, if the confidence score check at step 1314 identifies a high confidence detection matching a threshold, the workflow proceeds to step 1316, where the system flags the detection as a unique or marginal sample. At step 1317, the system captures and saves an image crop to a local buffer. The process then determines at step 1318 whether a paired mobile application (RODAN App) is connected. Upon confirming connection, step 1319 involves synchronizing and transferring the buffer to the smartphone via a high-speed wireless link, such as Wi-Fi Direct.

Once transferred, a background training phase is initiated at step 1320, during which the smartphone's Neural Processing Unit (NPU) retrains the classification layers of the model. Following retraining, at step 1321, the refined model is subjected to human-in-the-loop review through user labeling within the mobile application. After approval, the workflow proceeds to step 1322, where a hardware hot-swap of the model engine is executed. Finally, at step 1323, the updated model engine is shipped back to the portable hardware unit to feed back into the real-time collision detection logic.

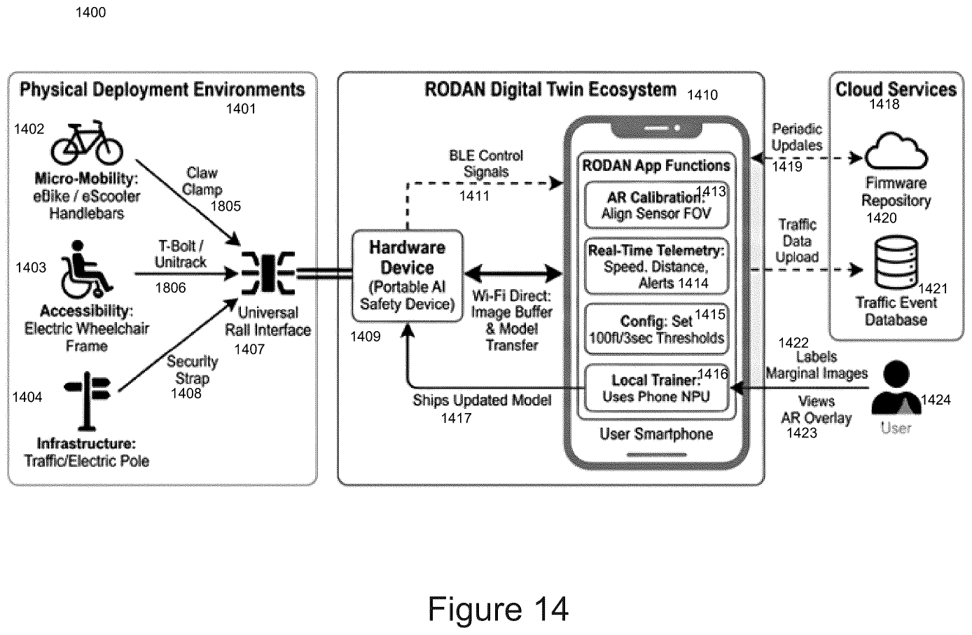

### FIG. 14: Device Connectivity and Interaction Diagram—Digital Twin Ecosystem

FIG. 14 illustrates a comprehensive system architecture diagram depicting the connectivity and interaction pathways within a digital twin ecosystem 1400 for the intelligent vehicle safety and traffic monitoring system. The diagram shows the integration of physical deployment environments, edge computing hardware, digital twin processing infrastructure, and cloud-based services, along with the bidirectional data flows and control signals connecting these subsystem components.

### Physical Deployment Environments

The left portion of the diagram depicts physical deployment environments 1401 representing the real-world contexts in which the hardware safety devices are installed and operated. These physical environments comprise multiple deployment scenarios:

Micro-Mobility Deployment 1402: A bicycle icon represents deployment on micro-mobility vehicles including bicycles and electric scooters. These lightweight personal transportation devices benefit from the safety monitoring capabilities adapted for lower-speed urban navigation scenarios.

Accessibility Device Deployment 1403: A wheelchair icon represents deployment on accessibility devices including electric wheelchairs and motorized mobility scooters for physically disadvantaged persons. This deployment provides enhanced environmental awareness and obstacle detection for vulnerable users navigating pedestrian and roadway environments.

Infrastructure Deployment 1404: A traffic pole icon represents fixed infrastructure installations where the device is mounted on traffic poles, electric poles, or dedicated monitoring structures to provide stationary traffic observation capabilities.

These physical deployment environments 1401 connect to the central hardware safety device through various interface mechanisms indicated by labeled connection pathways.

### Interface and Communication Pathways

Multiple interface types facilitate communication between physical deployment contexts and the hardware device:

Clear Display Interface 1405: A bidirectional connection labeled “Clear Display” provides visual output from the device to users in micro-mobility contexts, enabling real-time alert presentation on integrated display screens.

T-Bolt/D-Bracket Mounting 1406: A connection pathway labeled “T-Bolt/D-Bracket” indicates physical mounting mechanisms securing the device to wheelchair frames and mobility device structures.

Universal Interface 1407: A connection labeled “Universal Interface” provides standardized connectivity accommodating diverse device types and mounting configurations across different physical deployment scenarios.

Security Strap 1408: A connection labeled “Security Strap” indicates physical attachment mechanisms preventing device theft or displacement when installed on publicly accessible infrastructure or personal mobility devices.

These interface pathways converge at the central hardware safety device component.

### Hardware Safety Device

The central component of the ecosystem is the hardware safety device 1409, depicted as a rectangular block labeled “Hardware Safety Device” positioned at the intersection of the physical deployment environments and the digital twin ecosystem. This hardware device comprises the edge computing platform, imaging sensors, communication modules, and alert generation components described in previous figures.

The hardware device 1409 serves as the primary data acquisition node, capturing real-time environmental data through imaging sensors and executing machine learning inference at the edge. The device maintains bidirectional communication with both the physical deployment environments (receiving power and mounting support, providing alert outputs) and the digital twin ecosystem (transmitting telemetry data, receiving model updates).

### RODAN Digital Twin Ecosystem

The central and right portions of the diagram depict the RODAN Digital Twin Ecosystem 1410, represented by a large rectangular region with rounded corners. This ecosystem comprises cloud-based and edge-based software components that create virtual representations of physical devices, process aggregated data, and provide advanced analytics and control capabilities.

The digital twin ecosystem 1410 is subdivided into multiple functional modules:

### BLE Control Module

At the top of the digital twin ecosystem, a BLE (Bluetooth Low Energy) Control module 1411 manages wireless communication between hardware devices and mobile applications. This module handles connection establishment, data packet transmission, and protocol management for Bluetooth-based device interactions. Bidirectional arrows indicate two-way communication between the hardware safety device 1409 and the BLE Control module 1411.

### RODAN App Functions

Below the BLE Control module, a subsection labeled “RODAN App Functions” 1412 encompasses multiple application-layer capabilities:

AR Calibration and Visualization 1413: This function provides augmented reality capabilities for device calibration and real-time alert visualization overlaid on camera feeds. Users can visualize detected objects and alerts through AR interfaces on mobile devices, enhancing situational awareness beyond conventional 2D map displays.

Real-Time Telemetry and Data Queries 1414: This function manages continuous streaming of telemetry data from deployed hardware devices, enabling real-time monitoring of device status, detection events, and operational parameters. The function supports user queries for historical data retrieval and real-time device status verification.

### Configuration Management

A “Config. Set” (Configuration Set) module 1415 provides centralized management of device configuration parameters. Users or system administrators can adjust detection thresholds, alert sensitivities, communication settings, and operational modes through this configuration interface. Configuration changes propagate from the digital twin ecosystem to physical hardware devices via the established communication pathways.

### Local Training and Model Management

A “Local Trainer: Uses Smartphone NPU” module 1416 implements on-device machine learning model training utilizing smartphone neural processing unit capabilities. This module corresponds to the smartphone-based image labeling functionality described in FIG. 9, enabling distributed model refinement without requiring all training computation to occur in centralized cloud infrastructure.

The module processes captured traffic sign images, performs preliminary classification and labeling, and contributes to the continuous model improvement pipeline. By leveraging smartphone NPU hardware acceleration, the system offloads computational work from cloud servers while maintaining rapid processing speeds.

### Model Deployment Pipeline

Adjacent to the local trainer, a “Ships Updated Model” indicator 1417 represents the model distribution mechanism whereby retrained and improved machine learning models are packaged and transmitted back to hardware devices. Arrows indicate the flow of updated models from the digital twin ecosystem back to the hardware safety device 1409, completing the continuous improvement cycle.

### Cloud Services Infrastructure

The right portion of the diagram depicts Cloud Services 1418, representing remote server infrastructure hosting centralized data storage, computation, and analytics capabilities.

### Periodic Model Updates

A “Periodic Model Updates” module 1419 manages scheduled distribution of machine learning model updates to deployed device populations. This module implements version control, compatibility verification, and staged rollout procedures ensuring model updates deploy successfully across diverse hardware configurations without disrupting device operation.

### Traffic Sign Repository

A “Traffic Sign Repository” 1420 comprises a centralized database storing the comprehensive traffic sign dataset used for model training. This repository aggregates traffic sign images collected from all deployed devices, maintains image metadata and classification labels, and serves as the authoritative dataset for periodic model retraining operations.

### Traffic Event Database

A “Traffic Event Database” 1421 stores historical records of all detected traffic events, alerts generated, and driving behavior observations captured by the deployed device population. This database enables longitudinal analysis of traffic patterns, safety incident correlations, and system performance metrics across geographic regions and time periods.

### Image Management and Analytics

Two additional cloud service components support image processing workflows:

Labels and Manual Image Review 1422: This module provides interfaces for expert reviewers to manually verify traffic sign classifications, correct labeling errors, and validate automatically generated labels before incorporating images into training datasets. Human review ensures dataset quality and prevents model degradation from incorrectly labeled training examples.

Views and AR Rendering 1423: This module generates augmented reality visualization data and renders complex graphical views for presentation in mobile applications and web dashboards. The module processes raw sensor data and detection results into user-friendly visual formats.

A user icon 1424 represents human operators, administrators, or end users who interact with the cloud services through web dashboards and mobile applications to access analytics, configure systems, and review safety data.

### Data Flow and Interaction Pathways

Bidirectional arrows throughout the diagram indicate data and control signal flows:

Physical devices transmit telemetry, image data, and detection events to the digital twin ecosystem via the hardware safety device 1409

The digital twin ecosystem processes data, updates digital twin representations, and forwards selected data to cloud services for long-term storage and analysis

Cloud services perform computationally intensive operations including model retraining, aggregate analytics, and large-scale data queries

Updated models and configuration parameters flow from cloud services through the digital twin ecosystem back to physical hardware devices

Users interact with cloud services to access dashboards, generate reports, and modify system configurations, with changes propagating through the ecosystem to affect device behavior

### Ecosystem Integration and Digital Twin Concept

The architecture depicted in FIG. 14 implements a comprehensive digital twin paradigm wherein each physical hardware device 1409 has a corresponding virtual representation within the RODAN Digital Twin Ecosystem 1410. The digital twin maintains real-time synchronized state with its physical counterpart, receiving continuous telemetry updates reflecting the physical device's operational status, environmental observations, and detection events.

This digital twin architecture enables several advanced capabilities:

Remote Monitoring: Operators can observe device status and detection activity from centralized dashboards without physical access to deployed hardware

Predictive Maintenance: Analysis of telemetry patterns can identify devices requiring maintenance before failures occur

Coordinated Updates: Configuration changes and model updates can be deployed simultaneously across device populations

Virtual Testing: New algorithms and configurations can be validated against recorded telemetry data in the digital twin environment before deployment to physical devices

Aggregate Analytics: Data from multiple digital twins can be analyzed collectively to identify systemic patterns invisible at individual device level

The ecosystem architecture thereby transforms individual standalone safety devices into an interconnected network of intelligent sensors contributing to comprehensive traffic safety infrastructure, with the digital twin layer providing the integration, coordination, and intelligence amplification necessary to realize network-wide benefits exceeding the sum of individual device capabilities.

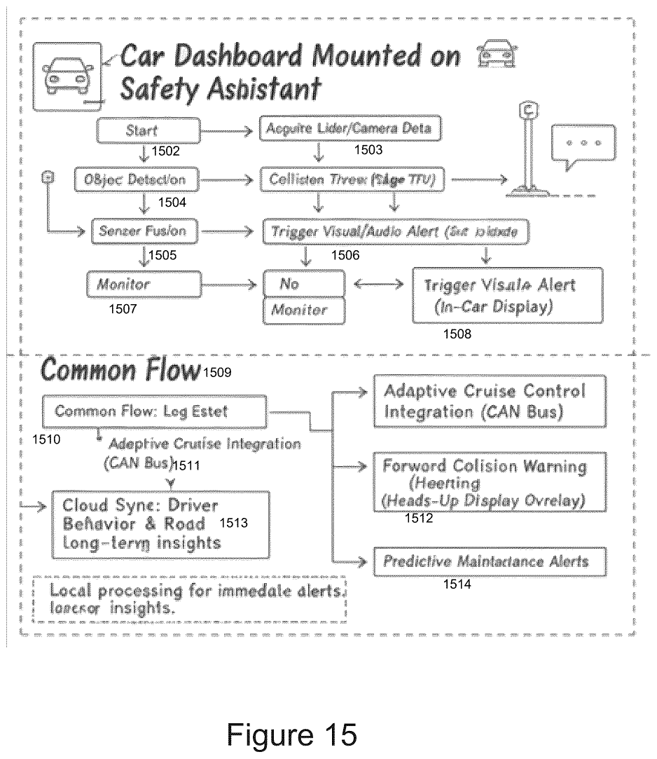

FIG. 15 illustrates an embodiment of a car-dashboard-mounted safety assistant and associated common data flow 1501. In the upper portion of FIG. 15, a real-time collision detection and alert sequence is shown for a dashboard-mounted assistant. The process begins at a start node 1502 and proceeds to an acquire LiDAR/camera data step 1503, in which the device collects environmental imagery and ranging information. An object-detection step 1504 executes a collision-threat model on an edge tensor processing unit to identify potential hazards. A sensor-fusion step 1505 combines LiDAR and camera outputs, and a trigger visual/audio alert step 1506 generates alerts suitable for roadside or external notification. A monitor decision step 1507 determines whether monitoring continues; if the monitoring condition is not met, a trigger visual alert step 1508 presents an in-car display notification. The lower portion of FIG. 15 depicts a common flow 1509, in which a common-flow logic block 1510 interfaces with an adaptive cruise control integration module on a CAN bus 1511, forwards collision-warning data for a heads-up-display overlay 1512, synchronizes driver-behavior and road-condition information to a cloud-sync module 1513 for long-term insights, and generates predictive maintenance alerts 1514 while providing local processing for immediate alerts and longer-term analytics.

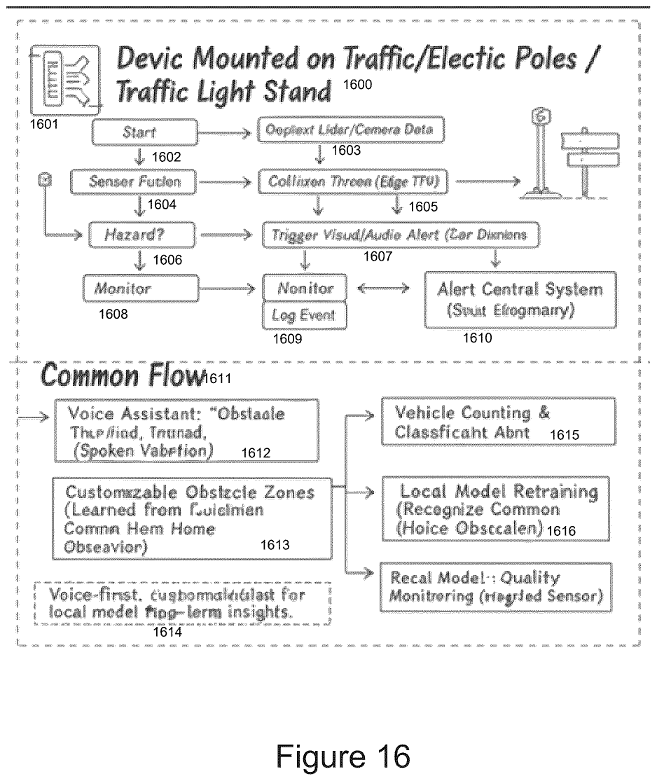

FIG. 16: Real-Time Collision Detection Logic Flow for Infrastructure-Mounted Devices

FIG. 16 illustrates a logic flow diagram depicting real-time collision detection and alert generation methods for intelligent safety devices mounted on traffic poles, electric poles, or traffic light stands. The diagram is divided into two main sections: an upper infrastructure-mounted device processing flow 1600 and a lower common flow section 1610 describing shared functionalities across deployment configurations.

### Infrastructure-Mounted Device Processing Flow

The upper section of the diagram depicts the primary processing sequence for devices deployed on fixed infrastructure, with a small icon 1601 representing a traffic pole or electric pole installation showing the physical mounting context.

System Initialization: The process commences at a “Start” node 1602, indicating system power-up and initialization of the infrastructure-mounted device. Upon initialization, the device activates its sensors and begins monitoring the surrounding traffic environment.

Lidar and Camera Data Acquisition: At step 1603, labeled “Deploy Lidar/Camera Data,” the system captures environmental data through integrated LIDAR (Light Detection and Ranging) sensors and camera imaging sensors. The LIDAR sensors provide precise distance measurements and three-dimensional point cloud data representing objects in the monitored area, while cameras capture visual imagery for object classification and scene understanding. The combined sensor modalities provide complementary data enabling robust object detection under diverse environmental conditions.

Sensor Fusion Processing: At step 1604, labeled “Sensor Fusion,” the system integrates data streams from multiple sensor types into a unified environmental representation. Sensor fusion algorithms align LIDAR point clouds with camera imagery, correlate detections across sensors, resolve conflicts between sensor readings, and generate a coherent model of the traffic scene incorporating spatial positions, object classifications, and movement vectors. This fusion process improves detection accuracy and reduces false positives compared to single-sensor approaches.

Edge Processing Unit Analysis: Following sensor fusion, data flows to step 1605, labeled “Collision Threat (Edge TPU),” where an edge Tensor Processing Unit (TPU) executes machine learning inference to assess collision threats. The edge TPU, representing hardware-accelerated AI processing capabilities integrated within the infrastructure-mounted device, analyzes fused sensor data to identify potential collision scenarios including vehicle-to-vehicle conflicts, vehicle-to-pedestrian risks, and vehicle-to-infrastructure impacts. The edge computing approach enables real-time threat assessment with latency suitable for safety-critical applications, processing data locally without requiring round-trip communication to remote servers.

Hazard Determination: The collision threat assessment produces a binary hazard determination at decision node 1606, labeled “Hazard?” This decision point evaluates whether detected conditions meet threshold criteria for hazard classification based on factors including object proximity, closing velocity, trajectory intersection, and time-to-collision calculations. If conditions indicate imminent collision risk, the process proceeds to alert generation; if no hazard is detected, the system continues monitoring without generating alerts.

Alert Generation: When a hazard is detected, the system proceeds to step 1607, labeled “Trigger Visual/Audio Alert (Car Drivers),” where alerts are generated to warn affected road users. For infrastructure-mounted deployments, alerts may include activation of visual warning displays such as flashing lights or digital signage visible to approaching drivers, broadcast of audio alerts through loudspeakers mounted on the infrastructure, and transmission of wireless alerts to vehicles equipped with vehicle-to-infrastructure (V2I) communication capabilities. The alert modalities are selected based on the specific hazard type and the communication capabilities available at the installation site.

Monitoring and Logging Operations: Parallel to the primary detection flow, step 1608, labeled “Monitor,” represents continuous system health monitoring including sensor status verification, communication link testing, and performance metric tracking. An adjacent step 1609, labeled “Monitor Log Event,” captures timestamped records of all detection events, alerts generated, and system status changes. These logs are stored in local non-volatile memory for subsequent analysis and evidentiary documentation.

Central System Integration: A final component 1610, labeled “Alert Central System (Scout Efogmary),” represents connectivity to centralized traffic management systems. The infrastructure-mounted device transmits alert notifications and event data to central monitoring stations where traffic operators can coordinate responses, analyze traffic patterns across multiple monitoring locations, and integrate safety device data with other intelligent transportation system components. Bidirectional arrows indicate two-way communication enabling central systems to query device status and adjust detection parameters remotely.

### Common Flow Processing

The lower section of the diagram, enclosed in a dashed border and labeled “Common Flow” 1611, depicts processing functions applicable across multiple deployment configurations including both infrastructure-mounted and vehicle-mounted installations.

Voice Assistant Integration: Block 1612, labeled “Voice Assistant: ‘Obstacle The/Had, Tunnel’ (Spoken Vibration),” describes natural language alert generation capabilities. The system synthesizes spoken warnings describing detected hazards in conversational language, such as announcing “Obstacle ahead in tunnel” when detecting stopped vehicles or debris in tunneled roadway sections. The parenthetical notation “(Spoken Vibration)” indicates that audio alerts may be accompanied by haptic feedback for users with hearing impairments or in high-noise environments where audio alone may be insufficient.

Customizable Alert Zones: Block 1613, labeled “Customizable Obstacle Zones (Learned from Ephemeral Commn Hom Home Obscalearl),” describes adaptive zone configuration capabilities. The system learns typical traffic patterns and obstacle locations through observation of recurring events, enabling users to define custom alert zones around frequently encountered obstacles such as construction zones near the user's home, school crossing areas along regular commutes, or other location-specific hazards. The learning mechanism automatically adjusts alert sensitivity in these customized zones based on historical data.

Local Model Enhancement: Block 1614, labeled “Voice-first, customardigist for local model hop-term insights,” describes voice-based interaction capabilities for refining local detection models. Users can provide verbal feedback regarding alert accuracy, describe undetected hazards, or confirm correct detections, with this feedback incorporated into model refinement processes that improve detection performance in the user's specific geographic operating area.

Vehicle Counting and Classification: Block 1615, labeled “Vehicle Counting & Classificant Alert,” implements traffic flow analysis capabilities. The system counts vehicles passing through monitored areas, classifies vehicles by type (passenger cars, trucks, motorcycles, bicycles), and generates alerts when traffic volumes exceed configurable thresholds. This functionality supports traffic congestion detection and provides data for transportation planning purposes.

Local Model Retraining: Block 1616, labeled “Local Model Retraining (Recognize Common Hoice Obscalearl),” describes distributed model improvement mechanisms. The system identifies commonly encountered obstacle types specific to the deployment location—such as particular vehicle models frequently observed, regional traffic sign variations, or local architectural features—and refines detection models to optimize recognition of these recurring elements. This localization improves accuracy in the specific deployment context without requiring central retraining infrastructure.

Quality Monitoring: Block 1617, labeled “Recal Model: Quality Monitoring (Hegrded Sensor),” implements performance tracking for deployed models. The system continuously evaluates detection accuracy through sensor cross-validation, monitors false positive and false negative rates, and flags model performance degradation requiring retraining or recalibration. When quality metrics fall below acceptable thresholds, the system can automatically request updated models from cloud infrastructure or alert administrators to performance issues.

### Data Flow and System Integration

Arrows throughout the diagram indicate sequential process flow for the infrastructure-mounted configuration and parallel processing relationships for common flow functions. The infrastructure-mounted processing flow operates continuously in a loop, returning from alert generation and monitoring steps back to sensor data acquisition to maintain persistent environmental surveillance.

The common flow functions operate independently and in parallel with the primary detection pipeline, providing enhanced capabilities that augment core collision detection with user customization, quality assurance, and adaptive learning features. These common functions may execute at lower priority or reduced frequency compared to time-critical collision detection operations, ensuring safety-critical processing maintains real-time performance even when additional analytics are active.

### Infrastructure-Specific Deployment Considerations

The infrastructure-mounted configuration depicted in FIG. 16 differs from vehicle-mounted configurations in several key aspects. Infrastructure devices monitor fixed geographic areas rather than moving with a vehicle, enabling detection of hazards affecting multiple vehicles and pedestrians within the monitored zone. The broader field of view and stationary vantage point allow infrastructure devices to detect collision threats between multiple moving objects, whereas vehicle-mounted devices primarily focus on hazards affecting the host vehicle.

Infrastructure deployments further enable persistent monitoring regardless of traffic density, capturing events during all hours including periods when few vehicles are present. The fixed installation provides stable power sources and potentially higher-performance computing hardware compared to mobile deployments constrained by vehicle electrical systems and physical space limitations.

The integration with central traffic management systems (Scout Efogmary) 1610 enables infrastructure devices to contribute to network-wide traffic safety initiatives, coordinating alerts across multiple intersections, providing data for adaptive traffic signal control, and supporting emergency vehicle preemption systems that clear traffic paths for responding emergency services.

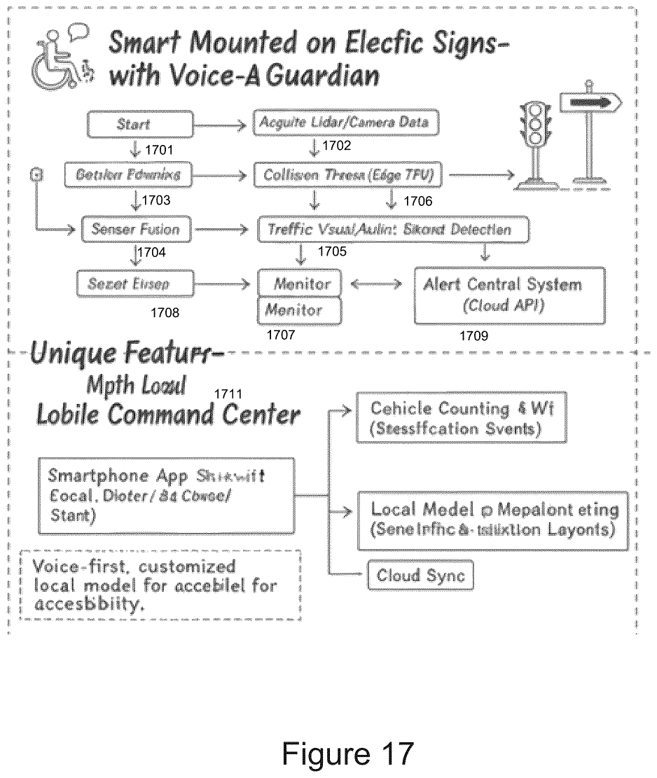

FIG. 17 is a flow diagram illustrating the Real-Time Collision Detection Logic executed by the portable hazard detection apparatus. The logic process initiates at step 1701, where sensors (including Lidar, Camera, and IM) are initialized and environmental data is acquired. Following acquisition, the data is processed at step 1702, which involves filtering noise and rectifying the frame to ensure data integrity. At step 1703, an Object Detection phase is performed by executing a machine learning model on the edge TPU.

The workflow then proceeds to step 1704, where Sensor Fusion occurs by mapping Lidar depth data to visual bounding boxes generated in the previous step. At step 1705, a Directionality Calculation is performed by fusing optical flow data with IM yaw to determine the trajectory of detected objects. The system then conducts an Intersection Test at step 1706 to determine if a detected object is within the vehicle's path vector. If no object is in the path, the logic proceeds to step 1707, where the detection is ignored as a false positive, and the system returns to data acquisition.

If an object is confirmed in the path vector, the logic moves to step 1708 for Hazard Evaluation, which calculates the relative velocity and Time-to-Collision (TTC). At step 1709, the system checks the calculated data against established Thresholds (e.g., TTC or distance settings). If the thresholds are not met, the process continues to step 1710 to continue monitoring without alerting. However, if the thresholds are exceeded at step 1709, the system executes step 1711, triggering an Action in the form of an audio or visual alert via the hardware unit and the paired mobile application.

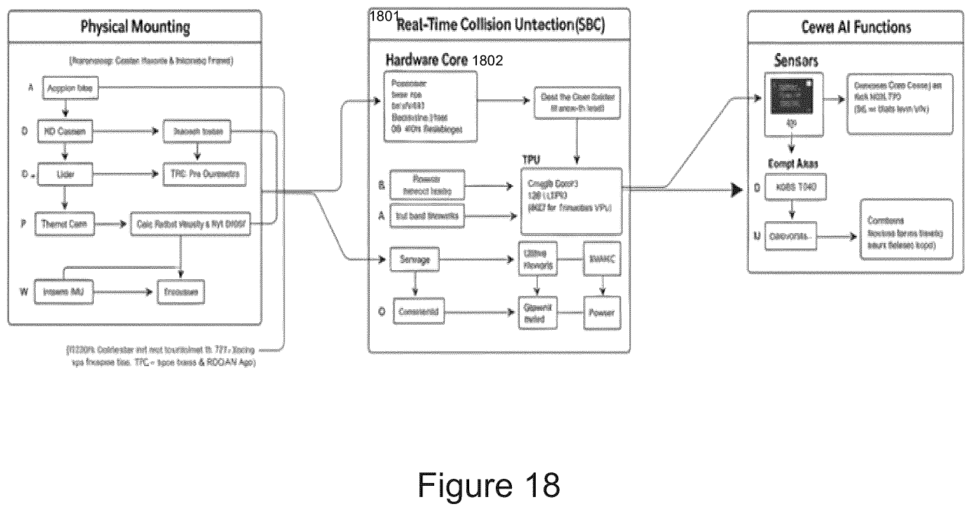

FIG. 18 provides a detailed flow diagram of the Real-Time Collision Detection Logic 1801 as executed by the core computing unit 1802 of the portable hazard detection apparatus. The logic sequence initiates at step, where the system initializes sensors and begins the acquisition of multi-modal data from the Lidar, optical camera, and IMU components. Once acquired, the data proceeds to step for preprocessing, which includes filtering environmental noise and rectifying the image frames for spatial accuracy. At step, the preprocessed data is fed into a machine learning model residing on the edge TPU for real-time object detection.

Following object detection, the workflow advances to step, where sensor fusion is performed by mapping Lidar-derived depth data to the visual bounding boxes generated by the camera. At step, a directionality calculation is executed by fusing optical flow data with IMU yaw rates to determine the precise vector of detected objects. An intersection test is then conducted at step to determine if a detected object is situated within the current path vector of the vehicle. If the object is not within the path, the system proceeds to step, where the detection is ignored as a false positive, and the logic loops back to initial data acquisition.

If an object is confirmed within the path vector at step, the logic moves to step for hazard evaluation, which involves calculating the relative velocity of the object and the estimated Time-to-Collision (TTC). At step, the system performs a threshold check to determine if the calculated TTC or physical distance is less than user-defined safety settings. If the thresholds are not met, the process proceeds to step to continue monitoring without intervention. However, if the thresholds are met or exceeded at step, the logic triggers step, executing an action such as an audio or visual alert delivered through both the hardware unit and the paired mobile application (RODAN App).

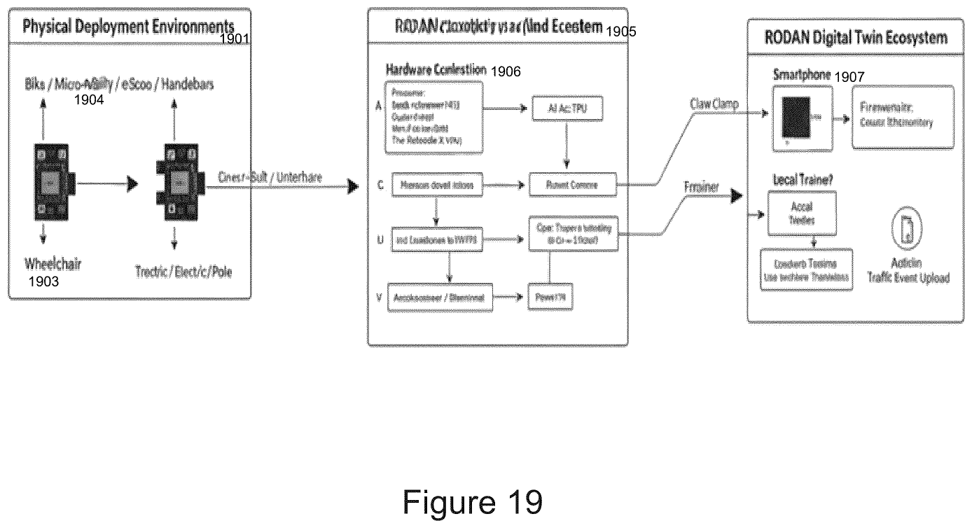

FIG. 19 illustrates an embodiment of a deployment and digital-twin ecosystem for a real-time collision detection platform. On the left, a physical deployment environments 1901 block depicts the apparatus mounted to various vehicle types, including wheelchairs 1903 and bikes, micro-mobility devices, e-scooters, or handlebars of electric vehicles 1904, using a configurable clamp or interface. A central hardware-configuration block 1906 represents the in-vehicle sensing and computation stack, including a processor and AI accelerator subsystem, multi-modal sensors, local data storage and power management components, and communication interfaces. Outputs from the hardware-configuration block are provided to a RODAN digital-twin ecosystem block 1905. Within this ecosystem, a smartphone module executes a companion application configured to receive event data, perform local inference refinement, and synchronize traffic events to a cloud infrastructure. A local-trainer module utilizes the smartphone's 1907 processing resources to adapt or retrain machine-learning models, which are subsequently delivered back to the hardware-configuration block, thereby closing a loop between physical deployments and their digital-twin representations.

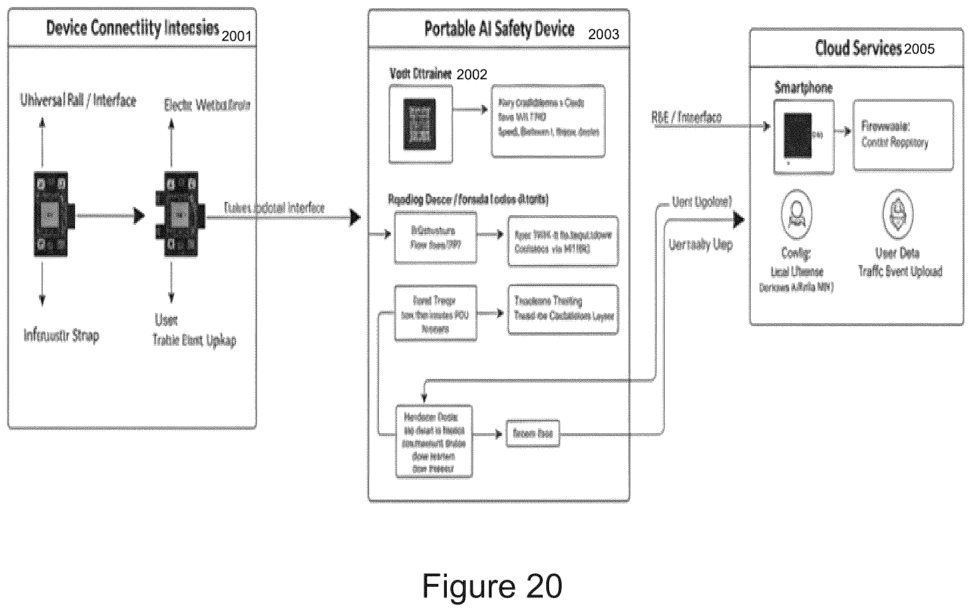

FIG. 20 illustrates an exemplary real-time collision detection logic flow implemented by a portable AI safety device and associated cloud services. As shown, one or more device connectivity interfaces 2001 receive raw sensor and operational data from external infrastructure straps, universal rail interfaces, and user traffic input sources. The received data is conditioned and normalized by an embedded electrical and logical interface module, which provides a low-latency data stream to the portable AI safety device 20032003. Within the portable AI safety device, a vetted AI inference 2002 engine executes trained collision-detection models to evaluate speed, trajectory, inertia, and proximity parameters in real time. In parallel, a signal decoding and feature extraction module parses incoming data packets to derive structured vectors used by the AI inference engine 2002. An event trigger and threshold analysis module compares inferred collision probabilities against dynamically adjustable safety thresholds to determine whether a collision risk condition exists. Upon detection of a qualifying collision risk, a hazard decision logic block generates one or more response commands, including local mitigation actions and alert signals. A secure communication interface transmits event data, model outputs, and device status information to a remote cloud service platform via a wired or wireless interface. The cloud service platform 2005 stores the received data within a centralized repository, performs user data correlation and traffic event aggregation, and provides configuration updates and model refinement parameters back to the portable AI safety device, thereby enabling continuous improvement of real-time collision detection performance.

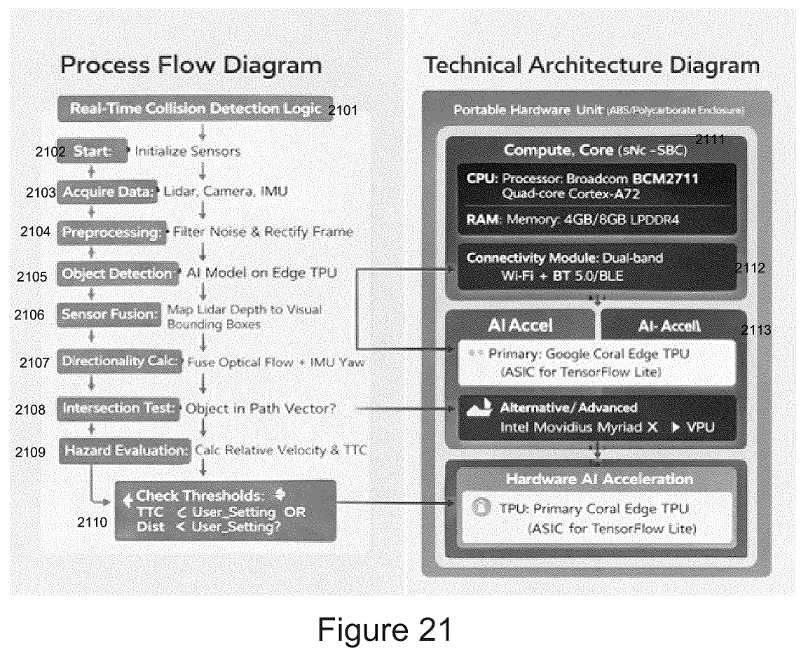

FIG. 21 illustrates an exemplary real-time collision detection logic flow 2001 and corresponding technical architecture executed by a portable hardware unit. As shown, the process begins 2102 with initialization of one or more onboard sensors, followed by acquisition of multi-modal sensor data including LiDAR, camera, and inertial measurement unit (IMIU) 2103 inputs. The acquired data is subjected to preprocessing 2104 operations that filter noise and rectify image frames to produce normalized sensor outputs. An object detection stage 2105 applies an artificial intelligence model executing on an edge-based tensor processing unit to identify objects within the sensed environment. Detected objects are then processed by a sensor fusion module 2106, which maps LiDAR-derived depth information to visual bounding boxes to generate unified spatial representations. A directionality calculation module 2107 fuses optical flow data with IMU yaw measurements to determine relative motion vectors. An intersection test module 2108 evaluates whether a detected object lies within a projected path vector of the portable hardware unit. A hazard evaluation module 2109 calculates relative velocity and time-to-collision parameters for objects determined to be in-path. A threshold comparison module 2110 compares the calculated time-to-collision and distance metrics against user-configurable safety thresholds to determine whether a collision risk condition exists. The logic flow is executed by a compute core 2111 including a multi-core processor and system memory, in cooperation with a connectivity module 2112 and one or more hardware AI acceleration components 2113, including a primary tensor processing unit and optional alternative vision processing units, thereby enabling low-latency, real-time collision detection within the portable hardware unit.

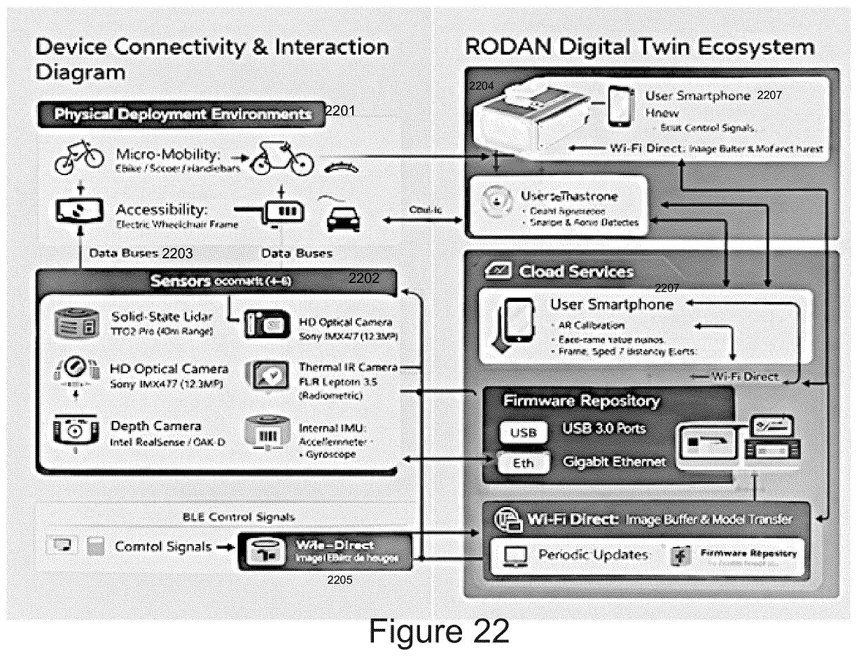

FIG. 22 illustrates an exemplary device connectivity and interaction architecture supporting real-time collision detection within a digital twin ecosystem. As shown, the system is deployed within one or more physical deployment environments 2201, including micro-mobility platforms, accessibility devices, and vehicular installations. A plurality of onboard sensors 2202 acquire environmental and motion data, including solid-state LiDAR, high-definition optical cameras, thermal imaging cameras, depth cameras, and inertial measurement components. Sensor outputs are conveyed over one or more internal data buses 2203 to an embedded processing device, which aggregates and time-aligns the sensor data for real-time analysis. Control and telemetry signals are exchanged via a short-range wireless interface 2205, including Bluetooth® low energy signaling and Wi-Fi Direct image buffering. The embedded processing device communicates, via a wireless network interface 2206, with a user smartphone 2207 that provides user interface functions, execution of supplemental control logic, and visualization of detected hazards. In parallel, the embedded processing device 2204 transmits sensor data, inference results, and event metadata to a cloud services platform, which maintains a digital twin representation of the physical deployment environment. The cloud services platform performs user authentication, data persistence, analytics, and alert generation, and stores firmware images and model updates within a firmware repository. Periodic and event-driven updates are delivered from the firmware repository to the embedded processing device and the user smartphone, thereby enabling coordinated operation, continuous system updates, and enhanced real-time collision detection across the device connectivity ecosystem.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and operations on data within a computer memory. An algorithm is here, and generally, conceived to be a self-consistent set of operations leading to a desired result.

To facilitate description, some elements of the system and/or the methods are referred to using the labels first, second, third, etc. These labels are intended to help to distinguish the elements but do not necessarily imply any particular order or ranking unless indicated otherwise.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The technology described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program object accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

The structure, algorithms, and/or interfaces presented herein are not inherently related to any particular computer or other apparatus. Various general-purpose systems may be used with programs in accordance with the teachings herein, or it may prove convenient to construct more specialized apparatus to perform the described methods. The structure for a variety of these systems will be apparent from the description above. In addition, the techniques introduced herein are not described with reference to any particular programming language. It will be appreciated that a variety of programming languages may be used to implement the techniques as described herein.

The foregoing description has been presented for the purposes of illustration and description. It is not intended to be exhaustive or to limit the techniques to the precise form disclosed. Many modifications and variations are possible in light of the above teaching. As will be understood by those familiar with the art, the techniques may be implemented in other specific forms without departing from the spirit or essential characteristics thereof. Likewise, the particular naming and division of the modules, routines, features, attributes, methodologies and other aspects are not mandatory or significant, and the mechanisms that implement the techniques or its features may have different names, divisions and/or formats.

What is claimed is:

1. A portable artificial intelligence (AI) safety apparatus comprising:
a single-board computer equipped with a dedicated hardware AI accelerator configured for high-speed object inference;
a multi-modal sensor suite operatively coupled to the single-board computer, the sensor suite comprising at least an optical camera, a solid-state LiDAR sensor, and a thermal infrared camera;
a modular mounting architecture comprising a plurality of interchangeable brackets configured to detachably secure the safety apparatus to diverse vehicle types; and
a local memory storing an ensemble of object detection models, wherein the single-board computer is configured to process data from the multi-modal sensor suite to generate a multi-modal alert based on a calculated time-to-collision.

2. The apparatus of claim 1, wherein the single-board computer is further configured to execute a situational rules engine that identifies a traffic congestion state by detecting a threshold number of at least five vehicles within a 30-meter radius of the apparatus for a sustained duration of at least 10 minutes.

3. The apparatus of claim 1, further comprising a wireless receiver configured to receive external traffic metrics from a highway infrastructure system, wherein the single-board computer fuses the external traffic metrics with the data from the multi-modal sensor suite to refine the calculated time-to-collision.

4. The apparatus of claim 1, wherein the ensemble of object detection models is configured to classify a detected object as a truck, and wherein the single-board computer generates a sequence of five early warnings if the truck is detected within a 100-meter range of the apparatus.

5. The apparatus of claim 1, wherein the single-board computer utilizes data from the solid-state LiDAR sensor to classify objects within a scanning range into categories comprising moving vehicles, stationary objects, physical structures, trees, animals, and human beings.

6. The apparatus of claim 1, wherein the single-board computer is further configured to monitor driver adherence to traffic rules by calculating a violation frequency metric based on a number of critical rule violations detected within a preceding one-hour temporal window.

7. The apparatus of claim 6, further comprising an internal-facing sensor configured to monitor driver physical posture and eyelid movement, wherein the single-board computer combines posture data and detected drowsiness patterns with the driver adherence monitoring to maintain a comprehensive behavioral awareness profile.

8. The apparatus of claim 7, wherein the single-board computer generates a driver-specific profile by aggregating the behavioral awareness profile with driving path data and precise geolocation tagging for use in urban traffic planning.

9. The apparatus of claim 1, wherein the apparatus is configured to be attached to and used on a micromobility vehicle.

10. The apparatus of claim 9, wherein the micromobility vehicle is from the group comprising a bicycle, an ebike, an escooter, or an electric wheelchair.

11. A portable hazard detection apparatus capable of localized model evolution, comprising:
a housing containing a single-board computer, a sensor array, the housing configured for temporary attachment to a vehicle;
an inference engine within the housing configured to classify traffic objects in real-time and identify low-confidence detections;
a data management subsystem configured to:
transmit captured images associated with the low-confidence detections to a paired mobile device via a local wireless connection; and
receive an updated machine learning model from the paired mobile device, wherein the updated model is refined using a neural processing unit of the paired mobile device; and
wherein the device is configured to replace an existing model with the updated machine learning model to improve detection accuracy for a specific geographic environment without requiring cloud connectivity.

12. The apparatus of claim 11, wherein the sensor array comprises a multi-modal suite including an optical camera, a solid-state LiDAR sensor, and a thermal infrared camera, and wherein the inference engine performs sensor fusion to classify the traffic objects.

13. The apparatus of claim 11, wherein the identification of low-confidence detections is based on a threshold probability score generated by the inference engine, and wherein a transmission of captured images is automatically triggered when the probability score falls below a predetermined limit.

14. The apparatus of claim 11, wherein the updated machine learning model is specifically optimized for local environmental factors comprising at least one of local traffic sign variations, unique infrastructure geometry, or specific regional vegetation.

15. The apparatus of claim 11, wherein the paired mobile device executes a digital twin application that provides a real-time graphical visualization of the inference engine's detection results and monitors a health status of the single-board computer.

16. The apparatus of claim 11, wherein the data management subsystem is configured to perform a decentralized handshake with the paired mobile device to ensure the updated machine learning model is compatible with hardware constraints of the single-board computer before replacement.

17. The apparatus of claim 11, further comprising an internal battery and a power management module configured to throttle the inference engine speed based on a thermal load generated during localized model evolution process.

18. The apparatus of claim 11, wherein the housing includes a universal mounting interface compatible with a plurality of interchangeable brackets for attachment to diverse vehicle types including bicycles, scooters, and electric wheelchairs.

19. The apparatus of claim 11, wherein the local wireless connection comprises a high-bandwidth Wi-Fi or Bluetooth Low Energy (BLE) link dedicated to transfer of high-resolution training datasets and model weights between the housing and the paired mobile device.

20. The apparatus of claim 11, wherein the data management subsystem further logs a temporal history of traffic rule violations detected by the inference engine, and wherein this temporal history is used by the paired mobile device to further refine the updated machine learning model.
